(19) United States
(12) Patent Application Publication
(10) Pub. No.: US 2026/0118801 A1
(43) Pub. Date: Apr. 30, 2026

(54) IMAGE FORMING APPARATUS

(71) Applicant: CANON KABUSHIKI KAISHA, Tokyo (JP)

(72) Inventors: YUSUKE MINATO, Ibaraki (JP); MANATO KOBAYASHI, Chiba (JP); IZURU TANAKA, Kanagawa (JP)

(21) Appl. No.: 19/367,345

(22) Filed: Oct. 23, 2025

(30) Foreign Application Priority Data
Oct. 25, 2024 (JP) 2024-188681

(51) Int. Cl. G03G 15/16; G03G 15/00; G03G 15/01

(52) U.S. Cl. CPC G03G 15/167; G03G 15/0131; G03G 15/0189; G03G 15/1605; G03G 15/80; G03G 2215/1633

(57) ABSTRACT

An image forming apparatus comprising: a photosensitive member, an intermediary transfer belt, a transfer member, an electrode member provided on an inner peripheral surface side of the intermediary transfer belt, a power source for applying a voltage of the same polarity as a predetermined polarity to the electrode member, and a supporting member for supporting the electrode member. The electrode member is supported in non-contact with the intermediary transfer belt when the electrode member is positioned in an operating position, and a separation amount between the electrode member and the intermediary transfer belt when the electrode member is positioned in the operating position is 1.5 mm or less.

### FIELD OF TECHNOLOGY

The present disclosure relates to an image forming apparatus such as a copying machine, a printer, a facsimile machine, or a multi-function machine having a plurality of functions of these machines, using an electrophotographic type or an electrostatic recording type.

### Description of Related Art

As an image forming apparatus, such as a color copying machine, a color printer, or a color multi-function machine, using the electrophotographic type, an image forming apparatus of an intermediary transfer type becomes mainstream since the image forming apparatus has advantages such that downsizing of an apparatus main assembly and adaptation to various recording materials are relatively easy. The image forming apparatus of the intermediary transfer type includes, in general, a constitution provided with a plurality of photosensitive drums and an intermediary transfer belt. Further, in such an image forming apparatus, toner images formed on the photosensitive drums are electrostatically primary-transferred successively onto the intermediary transfer belt in primary transfer portions. Then, the toner images primary-transferred on the intermediary transfer belt are electrostatically secondary-transferred onto a recording material such as paper in a secondary transfer portion. Incidentally, with respect to an arrangement of members around the primary transfer portions, “upstream” and “downstream” refer to “upstream” and “downstream”, respectively, with respect to a conveying direction of the intermediary transfer belt unless otherwise particularly specified.

In the image forming apparatus as described above, toner on the intermediary transfer belt has a tendency such that on a side downstream of a primary transfer portion, the toner is subjected to electric discharge between the intermediary transfer belt and the photosensitive drum and thus a charge amount of the toner increases. Then, the charge amount of the toner on the intermediary transfer belt increases, so that it becomes hard to transfer the toner onto a recording material in the secondary transfer portion in some instances. For example, a secondary transfer electric field necessary to transfer the toner onto the recording material in the secondary transfer portion becomes large, so that uniform transfer of the toner onto embossed paper with surface unevenness or the like becomes difficult.

Here, in Japanese Laid-Open Patent Application No. 2003-57963, a constitution in which an electroconductive contact plate is provided on a side downstream of the primary transfer portion and on an inner peripheral surface side of the intermediary transfer belt and in which a bias of the same polarity as a charge polarity of a photosensitive drum is applied to the contact plate is disclosed.

In order to suppress the increase in charge amount of the toner on the side downstream of the primary transfer portion as described above, suppression of the electric discharge on the side downstream of the primary transfer portion is effective. Further, for that purpose, it is effective that an electroconductive electrode member is provided on the side downstream of the primary transfer portion and on the inner peripheral surface side of the intermediary transfer belt and the bias of the same polarity as the charge polarity of the photosensitive drum is applied to this electrode member.

However, it was found that when the electrode member contacts an inner peripheral surface of the intermediary transfer belt, the toner on the intermediary transfer belt is scattered in some instances by an electric field formed under application of a voltage to the electrode member during passing of the toner through a region corresponding to the electrode member. When toner scattering occurs, there is a possibility that an inside of the image forming apparatus is contaminated with the toner.

### SUMMARY

The present disclosure is directed to improve a transfer property of a toner image onto a recording material, such as embossed paper, relatively different in toner image transfer while alleviating toner scattering in an image forming apparatus of an intermediary transfer type.

This is achieved by an image forming apparatus according to the present disclosure.

According to an aspect of the present disclosure, there is provided an image forming apparatus comprising: a photosensitive member capable of being electrically charged to a predetermined polarity and configured to bear a toner image; an intermediary transfer belt configured to convey the toner image transferred from the photosensitive member and capable of being circulated and moved; a transfer member configured to transfer the toner image from the photosensitive member onto the intermediary transfer belt; an electrode member provided on a side downstream of the transfer member with respect to a movement direction of the intermediary transfer belt and on an inner peripheral surface side of the intermediary transfer belt; a power source configured to apply a voltage of the same polarity as the predetermined polarity to the electrode member; and a supporting member configured to support the electrode member, wherein the electrode member is supported in non-contact with the intermediary transfer belt when the electrode member is positioned in an operating position, and a separation amount between the electrode member and the intermediary transfer belt when the electrode member is positioned in the operating position is 1.5 mm or less.

Further features of the present disclosure will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic block diagram of a control system of the image forming apparatus.

Parts (a) and (b) of FIG. 3 are a schematic sectional view and a schematic perspective view, respectively, of a potential regulating member.

FIG. 4 is a schematic sectional view of the potential regulating member in another example.

FIG. 5 is a schematic sectional view of the potential regulating member in another example.

FIG. 6 is a schematic sectional view for illustrating an arrangement of the potential regulating member.

Parts (a) and (b) of FIG. 7 are graphs each for illustrating an effect of the potential regulating member.

FIG. 8 is a schematic sectional view of a potential regulating member and a distance regulating member in another embodiment.

FIG. 9 is a schematic sectional view for illustrating an arrangement of the potential regulating member and the distance regulating member in the another embodiment.

FIG. 10 is a schematic sectional view of a potential regulating member and the distance regulating member in another embodiment.

FIG. 11 is a schematic sectional view for illustrating an arrangement of the potential regulating member and the distance regulating member in the another embodiment.

Parts (a) and (b) of FIG. 12 are a plan view and a sectional view, respectively, of a potential regulating member and a distance regulating member in another embodiment.

FIG. 13 is a schematic sectional view for illustrating an arrangement of the potential regulating member and the distance regulating member in the another embodiment.

Parts (a), (b), and (c) of FIG. 14 are schematic sectional views each showing a potential regulating member and a distance regulating member in another embodiment.

FIG. 15 is a schematic sectional view for illustrating toner scattering.

FIG. 16 is a schematic sectional view for illustrating an arrangement of a potential regulating member.

### DESCRIPTION OF THE EMBODIMENTS

In the following, an image forming apparatus according to the present disclosure will be described in more detail with reference to the drawings.

### Embodiment 1

### 1. General Structure and Operation of Image Forming Apparatus

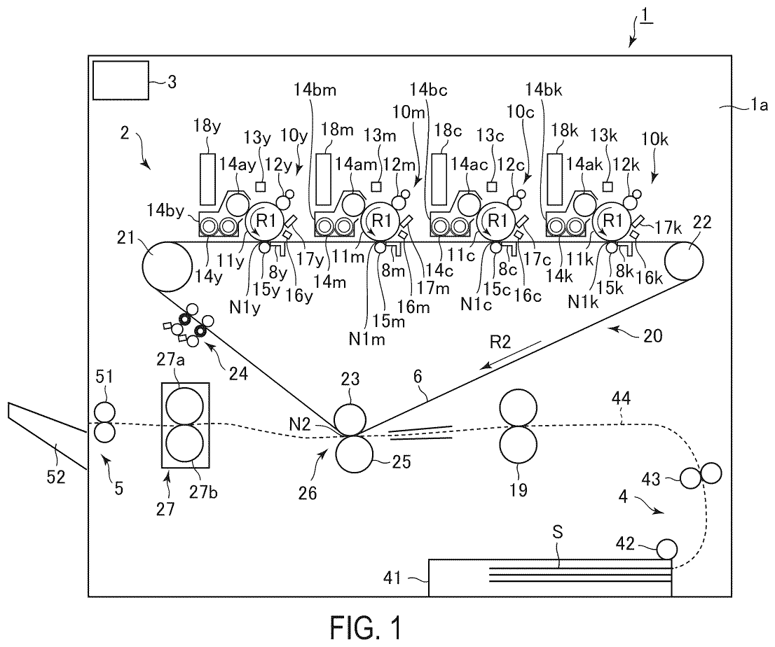

First, a general structure and an operation of the image forming apparatus of this embodiment will be described. FIG. 1 is a schematic sectional view of an image forming apparatus 1 of this embodiment. The image forming apparatus 1 of this embodiment is a tandem type full-color printer capable of forming a full-color image on a sheet-like recording material S by using an electrophotographic type and employing an intermediary transfer type.

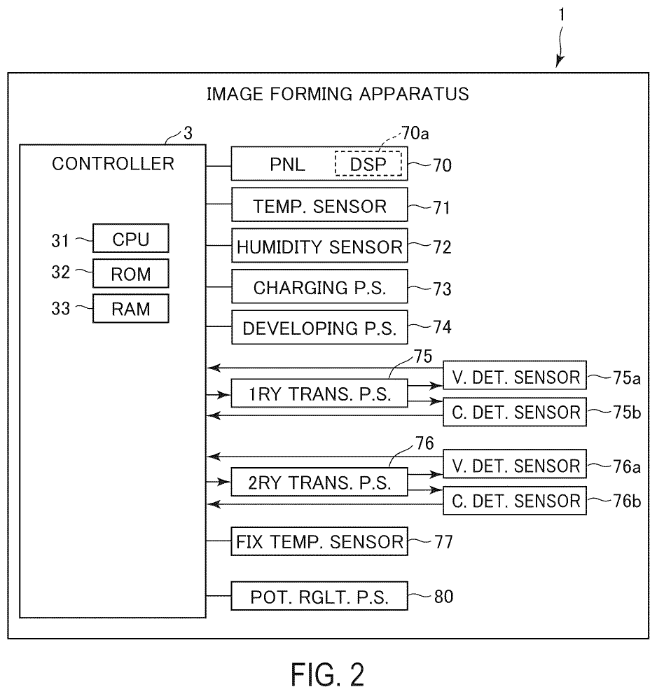

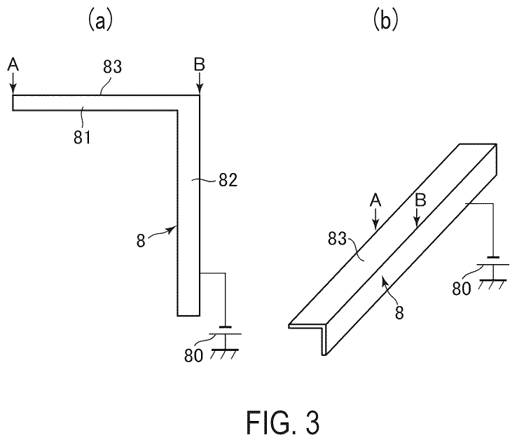

The image forming apparatus 1 includes image forming portion 2, a controller 3, a feeding portion 4 of the recording material S, and a discharging portion 5 of the recording material S. Further, inside the image forming apparatus 1, a temperature sensor 71 (FIG. 2) capable of detecting a temperature inside the apparatus and a humidity sensor 72 (FIG. 2) capable of detecting a humidity inside the apparatus are provided. The image forming apparatus 1 is capable of forming an image on the recording material S on the basis of image information (image signal) acquired by an original reading apparatus (not shown) provided on the image forming apparatus 1 or connected to the image forming apparatus 1. Further, the image forming apparatus 1 is capable of forming an image on the recording material S on the basis of image information (image signal) from an external device (not shown), such as a personal computer (host device), a digital camera, or a smartphone, connected to the image forming apparatus 1. Incidentally, the recording material (transfer material, recording medium, sheet) S is a material on which a toner image is formed. Specific examples of the recording material S include plain paper, thick paper, gloss coated paper, mat coated paper, embossed paper, or synthetic resin sheets (synthetic paper) which are substitutes for plain paper or the like, and an overhead projector sheet (resin film). Here, the recording material S is referred to as “paper” (“paper”, “embossed paper”, “high-resistance paper”, or the like) in some instances, but even in that case, the recording material S includes a material other than the paper or a recording material formed with a material containing the material other than the paper.

The image forming portion 2 forms the image on the recording material S, fed from the feeding portion 4, on the basis of the image information. The image forming portion 2 includes image forming units 10y, 10m, 10c, 10k, toner bottles 18y, 18m, 18c, 18k, exposure devices 13y, 13m, 13c, 13k, an intermediary transfer unit 20, a secondary transfer device 26, and a fixing device 27. The image forming units 10y, 10m, 10c and 10k form toner images of colors of yellow (y), magenta (m), cyan (c), and black (k), respectively. Incidentally, elements having the same or corresponding functions or structures provided for the respective colors will be collectively described by omitting suffixes y, m, c and k for representing elements for associated colors, respectively, in some instances. Further, the image forming apparatus 1 can also form, for example, a single-color image such as a (single) black image or a multi-color image by using the image forming unit(s) 10 for a desired single color or some of the four colors.

The image forming unit 10 includes a photosensitive drum 11 which is a drum-type (cylindrical) photosensitive member (electrophotographic photosensitive member) as an image bearing member. In addition, the image forming unit 10 includes a charging roller 12 which is a roller-type charging member as a charging means. In addition, the image forming unit 10 includes a developing device 14 as a developing means. In addition, the image forming unit 10 includes a pre-exposure device 16 as a discharging (charge eliminating) means. In addition, the image forming unit 10 includes a drum cleaning device 17 as a photosensitive member cleaning means. The image forming unit 10 forms a toner image on an intermediary transfer belt 6 described hereinafter.

The photosensitive drum 11 is movable (rotatable) while carrying (bearing) an electrostatic image (electrostatic latent image) or a toner image. In this embodiment, the photosensitive drum 11 is a drum-type photosensitive member provided with a negatively chargeable organic photosensitive member (OPC), and an outer diameter thereof is 30 mm. This photosensitive drum 11 is electrically chargeable to a negative polarity as a predetermined polarity. The photosensitive drum 11 includes an aluminum cylinder as a substrate and a surface layer (photosensitive layer) formed on the surface of the substrate. In this embodiment, as the surface layer, three layers of an undercoat layer, a charge generation layer, and a charge transportation layer, which are applied and laminated on the substrate in the order named are provided. When an image forming operation is started, the photosensitive drum 11 is rotationally driven in a direction indicated by an arrow R1 (counterclockwise) direction in FIG. 1 at a predetermined peripheral speed (process speed) by a driving motor (not shown) as a driving means.

The surface of the rotating photosensitive drum 11 is uniformly electrically charged by the charging roller 12. In this embodiment, the charging roller 12 is a rubber roller which contacts the surface of the photosensitive drum 11 and which is rotated with the rotation of the photosensitive drum 11. To the charging roller 12, a charging power source 73 (FIG. 2) as a charging voltage applying means (charging voltage applying portion) is connected. The charging power source 73 applies a predetermined charging voltage (charging bias) to the charging roller 12 during the charging process.

The surface of the charged photosensitive drum 11 is scanned and exposed by the exposure device 13 on the basis of the image information, so that an electrostatic image is formed on the photosensitive drum 11. The exposure device 13 is a laser scanner in this embodiment. The exposure device 13 emits laser beam (light) in accordance with separated color image information outputted from the controller 3, and scans and exposes the surface (outer peripheral surface) of the photosensitive drum 11.

The electrostatic image formed on the photosensitive drum 11 is developed (visualized) by supplying the toner thereto by the developing device 14, so that a toner image (toner picture, developer image) is formed on the photosensitive drum 11. In this embodiment, the developing device 14 is a two-component developing device using, as a developer, a two-component developer comprising toner (non-magnetic toner particles) and a carrier (magnetic carrier particles). In a developing container (developing container main body) 14b of the developing device 14, the two-component developer is accommodated, and toner in an amount corresponding to a consumed amount of the toner is supplied from the toner bottle 18. The developing device 14 includes a developing sleeve 14a as a developing member (developer carrying member). The developing sleeve 14a is constituted by, for example, a non-magnetic material such as aluminum or non-magnetic stainless steel (aluminum in this embodiment). Inside the developing sleeve 14a, a magnet roller (not shown) which is a roller-shaped magnet as a magnetic field-generating means (magnetic field-generating member) is fixed and arranged so as not to rotate relative to the developing container 14b. The developing sleeve 14a carries the two-component developer and conveys it to a developing region opposing the photosensitive drum 11. Then, in the developing region, the toner is moved to and deposited on an image portion of the electrostatic image on the photosensitive drum 1 from the two-component developer on the developing sleeve 14a. A developing power source 74 (FIG. 2) as a developing voltage applying means (developing voltage applying portion) is connected to the developing sleeve 14e. The developing power source 74 applies a predetermined developing voltage (developing bias) to the developing sleeve 14a during the development. In this embodiment, on an exposed portion (image portion) on the photosensitive drum 11 lowered in absolute value of the potential by being exposed after being uniformly charged, the toner charged to the same polarity (negative polarity in this embodiment) as the charge polarity of the photosensitive drum 11 is deposited (reverse development type). In this embodiment, a normal charge polarity of the toner, which is a principal charge polarity of the toner during the development, is the negative polarity.

The intermediary transfer unit 20 is arranged so as to oppose the four photosensitive drums 11y, 11m, 11c and 11k. The intermediary transfer unit 20 includes the intermediary transfer belt 6 which is constituted by an endless belt as an intermediary transfer member. The intermediary transfer belt 6 is wound around and stretched by, as a plurality of stretching rollers, a driving roller 21, a tension roller 22, and an inner secondary transfer roller 23. The intermediary transfer belt 6 is movable (rotatable, capable of being circulated and moved) while carrying the toner image. The driving roller 21 is rotationally driven by a driving motor (not shown) as a driving means, so that a driving force is transmitted to the intermediary transfer belt 6, and thus the intermediary transfer belt 6 is rotated (circulated and moved) in an arrow R2 direction (clockwise direction) in FIG. 1 at a predetermined peripheral speed corresponding to the peripheral speed of the photosensitive drum 1. The tension roller 22 controls the tension of the intermediary transfer belt 6 to be constant. The tension roller 22 is subjected to a force which pushes the intermediary transfer belt 6 from an inner peripheral surface (back surface) side toward an outer peripheral surface (front surface) side by an urging force of a tension spring (not shown) constituted by a compression coil spring which is an urging member as an urging means. By this force, a tension of about 2 to 5 kgf is applied to the intermediary transfer belt 6 in the feeding (conveying) direction (process progression direction, movement direction) of the intermediary transfer belt 6. The inner secondary transfer roller 23 constitutes a secondary transfer device 26 in combination with an outer secondary transfer roller 25 described hereinafter. On the inner peripheral surface side of the intermediary transfer belt 6, primary transfer rollers 15y, 15m, 15c, and 15k, which are roller-type primary transfer members as primary transfer means, are provided correspondingly to the photosensitive drums 11y, 11m, 11c, and 11k, respectively. In this embodiment, the primary transfer rollers 15 are disposed opposed to the photosensitive drums 11 and nip the intermediary transfer belt 6 between themselves and the photosensitive drums 11. Each of the primary transfer rollers 15 is pressed toward the photosensitive drum 11 and contacts the photosensitive drum 11 by way of the intermediary transfer belt 6, and forms a primary transfer portion (primary transfer nip) N1 which is a contact portion between the photosensitive drum 11 and the intermediary transfer belt 6.

The toner image formed on the photosensitive drum 11 is transferred (primarily transferred) onto the intermediary transfer belt 6 in the primary transfer portion N1 by the action of the primary transfer roller 15. For example, during formation a full-color image, the yellow, magenta, cyan and black toner images formed on the photosensitive drums 11 are multiple-transferred so as to be sequentially superimposed on the intermediary transfer belt 6. A primary transfer power source 75 (FIG. 2) as a primary transfer voltage applying means (primary transfer voltage applying portion) is connected to the primary transfer roller 15. During the primary transfer, the primary transfer power source 75 applies, to the primary transfer roller 15, a primary transfer voltage (primary transfer bias) which is a DC voltage having an opposite polarity (positive polarity in this embodiment) to the normal charge polarity of the toner. By this, the toner image formed with toner having the negative polarity on the photosensitive drum 11 is primarily transferred onto the intermediary transfer belt 6. To the primary transfer power source 75, a voltage detecting sensor 75a (FIG. 2) as a voltage detecting means (voltage detecting portion) which detects an output voltage thereof and a current detecting sensor 75b (FIG. 2) as a current detecting means (current detecting portion) which detects an output current thereof are connected. In this embodiment, for example, a primary transfer voltage of about 1 to 2 kV is applied to the primary transfer roller 15 (as regards a numerical range, “1 to 2 kV” shows a range including 1 kV and 2 kV, and the same applies hereinafter). In addition, in this embodiment, the primary transfer voltage is subjected to constant-voltage control. In this embodiment, the primary transfer power sources 75y, 75m, 75c and 75k are provided independently of the primary transfer rollers 15y, 15m, 15c and 15k, respectively. Further, in this embodiment, the primary transfer voltages applied to the primary transfer rollers 15y, 15m, 15c and 15k can be individually controlled.

Here, in this embodiment, the primary transfer roller 15 has a core metal and an elastic layer of ion conductive foam rubber (NBR rubber) formed at a periphery of the core metal. An outer diameter of the primary transfer roller 15 is, for example, 15 to 20 mm. In addition, as the primary transfer roller 15, a roller having an electric resistance value of 1×10⁵ to 1×10⁸ Ω (measured at N/N (23° C., 50%RH), 2 kV applied) can be preferably used.

Further, in this embodiment, the intermediary transfer belt 6 is an endless belt having a two-layer structure including a base layer, and a surface layer in the order named from the inner peripheral surface side toward the outer peripheral surface side. As the material constituting the base layer, a resin such as polyimide or polycarbonate, in which an appropriate amount of carbon black is contained as an antistatic agent can be used suitably. A thickness of the base layer is, for example, 0.05 to 0.15 mm. As a material constituting the surface layer, a resin such as chloroprene rubber (CR) to which electroconductivity is imparted by carbon black can be used suitably. A thickness of the surface layer is, for example, 0.200 to 0.300 mm. In this embodiment, the intermediary transfer belt 6 has a volume resistivity of 5×10⁸ to 1×10¹⁴ Ω.cm (23° C., 50%RH). Incidentally, in this embodiment, the two-layer structure was employed in the intermediary transfer belt 6, but a single-layer structure of a material corresponding to the material of the above-described base layer may also be employed. Further, the surface layer may also be formed as a resin-coated layer, of about 0.002 to 0.01 mm in thickness, containing a resin material such as a fluorine-containing resin. Further, the intermediary transfer belt 6 may have a multi-layer structure of three or more layers.

On the outer peripheral surface side of the intermediary transfer belt 6, the outer secondary transfer roller 25 which is a roller-type secondary transfer member as a secondary transfer means is provided. The outer secondary transfer roller 25 as the secondary transfer member constitutes the secondary transfer device 26 in cooperation with the inner secondary transfer roller 23 as an opposing member (opposing electrode). The outer secondary transfer roller 25 is pressed toward the inner secondary transfer roller 23, and contacts the inner secondary transfer roller 23 by way of the intermediary transfer belt 6 and forms a secondary transfer portion (secondary transfer nip) N2 which is a contact portion between the intermediary transfer belt 6 and the outer secondary transfer roller 25. The toner image formed on the intermediary transfer belt 6 is transferred (secondarily transferred) onto the recording material S, nipped and fed by the intermediary transfer belt 6 and the outer secondary transfer roller 25, by the action of the secondary transfer device 26 in the secondary transfer portion N2. To the outer secondary transfer roller 25, a secondary transfer power source 76 (FIG. 2) as a secondary transfer voltage applying means (secondary transfer voltage applying portion) is connected. During the secondary transfer, the secondary transfer power source 76 applies a secondary transfer voltage (secondary transfer bias), which is a DC voltage having an opposite polarity (positive polarity in this embodiment) to the normal charge polarity of the toner to the outer secondary transfer roller 25. By this, the toner image formed with toner having the negative polarity on the intermediary transfer belt 6 is secondarily transferred onto the recording material S. To the secondary transfer power source 76, a voltage detecting sensor 76a (FIG. 2) as a voltage detecting means (voltage detecting portion) for detecting the output voltage thereof and a current detecting sensor 76b (FIG. 2) as a current detecting means (current detecting portion) for detecting the output current thereof are connected. Further, the core metal of the inner secondary transfer roller 23 is connected to the ground potential. In this embodiment, for example, a secondary transfer voltage of about 1 to 6.5 kV is applied to the outer secondary transfer roller 25, and a secondary transfer current of about 15 to 100 μA is caused to flow through the secondary transfer portion N2, so that the toner image on the intermediary transfer belt 6 is secondarily transferred onto the recording material S. In this embodiment, the secondary transfer voltage is subjected to constant-voltage control. Incidentally, a constitution in which to the inner secondary transfer roller 23, as the secondary transfer member, the secondary transfer voltage which is the DC voltage of the same polarity as the normal charge polarity of the toner is applied from the secondary transfer power source 76, so that the outer secondary transfer roller 25 as the opposing member is connected to the ground potential may also be employed.

The recording material S is fed from the feeding portion 4 toward the secondary transfer portion N2 in parallel to the forming operation of the toner image onto the intermediary transfer belt 6. The recording material S is accommodated in a cassette 41 as a recording material accommodating portion of the feeding portion 4. The recording material S accommodated in the cassette 41 is separated and fed one by one from the cassette 41 by a feeding roller 42 or the like. This recording material S is conveyed by a conveying roller 43 or the like as a conveying member of the feeding portion 4 to a registration roller pair 19 as a conveying member provided in a conveying passage 44 of the recording material S. Then, this recording material S is conveyed to the secondary transfer portion N2 by being timed to the toner image on the intermediary transfer belt 6 by the registration roller pair 19. Incidentally, in FIG. 1, only one cassette 41 is illustrated, but the image forming apparatus 1 may also include a plurality of cassettes 41. Further, the feeding portion 4 may be capable of feeding the recording material S also from a recording material accommodating portion (recording material mounting portion) other than the cassette 41, such as a manual feeding tray or the like.

Here, in this embodiment, the outer secondary transfer roller 25 includes a core metal and an elastic layer of an ion conductive foam rubber (NBR rubber) formed around the core metal. An outer diameter of the outer secondary transfer roller 25 is, for example, 20 to 25 mm. In addition, as the outer secondary transfer roller 25, a roller having an electric resistance value of 1×10⁵ to 1×10⁸ Ω (measured at N/N (23° C., 50%RH), 2 kV applied) can be preferably used.

The recording material S onto which the toner image was transferred is fed to a fixing device 27 as a fixing means. The fixing device 27 includes a fixing roller 27a and a pressing roller 27b. The fixing roller 27a includes therein a heater as a heating means. The pressing roller 27b is press-contacted to the fixing roller 27a and thus forms a fixing portion (fixing nip). The fixing device 27 causes the recording material S carrying the unfixed toner image to be heated and pressed by nipping and feeding the recording material S between the fixing roller 27a and the pressing roller 27b, and thus causes the toner image to be fixed (melted, sticked) on the recording material S. Incidentally, the temperature of the fixing roller 27a (fixing temperature) is detected by a fixing temperature sensor 77 (FIG. 2). The recording material S on which the toner image was fixed is fed by a discharging roller pair 51 or the like, and is discharged (outputted) through a discharge opening (not shown), onto a discharge tray 52 provided outside an apparatus main assembly 1a of the image forming apparatus 1.

The surface of the photosensitive drum 11 after the primary transfer is electrically discharged by the pre-exposure device 16. In addition, toner remaining on the photosensitive drum 11 without being transferred onto the intermediary transfer belt 6 during the primary transfer (primary transfer residual toner) is removed from the surface of the photosensitive drum 11 by the drum cleaning device 17 and is collected. In this embodiment, the drum cleaning device 17 scrapes off the primary transfer residual toner from the surface of the rotating photosensitive drum 11 by a cleaning blade as a cleaning member, and collects the primary transfer residual toner in a collecting container (not shown). The cleaning blade is a plate-like member contacting the photosensitive drum 11 with a predetermined pressing force. The cleaning blade contacts the surface of the photosensitive drum 11 in a counter direction to the rotational direction of the photosensitive drum 11 so that a leading end thereof on a free end portion side faces the upstream side of the rotational direction of the photosensitive drum 11. Further, a deposited matter such as toner remaining on the intermediary transfer belt 6 without being transferred onto the recording material S during the secondary transfer (secondary transfer residual toner) or the like is removed and collected from the surface of the intermediary transfer belt 6 by a belt cleaning device 24 as an intermediary transfer member cleaning means.

Incidentally, the image forming unit 10 may constitute a cartridge (process cartridge) integrally detachably mountable to the apparatus main assembly 1a of the image forming apparatus 1. Further, in this embodiment, the intermediary transfer unit 20 is constituted by the intermediary transfer belt 6, the stretching rollers for the intermediary transfer belt 6, the respective primary transfer rollers 15, the belt cleaning device 24, and potential regulating members 8 and the like described later. The intermediary transfer unit 20 may be integrally detachably mountable to the apparatus main assembly 1a.

### 2. Control Constitution

Next, a constitution of a control system of the image forming apparatus 1 of this embodiment will be described. FIG. 2 is a block diagram showing a schematic constitution of the control system of the image forming apparatus 1 of this embodiment.

The image forming apparatus 1 is provided with the controller 3 (control circuit) as a control means. The controller 3 is constituted by including a CPU 31 as a calculating means, a ROM 32 as a storing means, a RAM 33 as a storing means, and an input/output circuit (I/F) (not shown) for inputting/outputting signals between itself and the external device. The ROM 32 stores programs or the like for controlling the respective portions of the image forming apparatus 1. The RAM 33 temporarily stores data on the control. The CPU 31 is a microprocessor which controls the entire image forming apparatus 1 and is a main part of a system controller. The CPU 31 is connected to the respective portions such as the feeding portion 4, the image forming portion 2, the discharge portion 5, and the like, and not only exchanges signals with these portions, but also controls the operation of each of these portions. The ROM 32 stores an image formation control sequence for forming the image on the recording material S.

To the controller 3, the charging power source 73, the developing power source 74, the primary transfer power source 75, the secondary transfer power source 76, and a potential regulating power source 80 described hereinafter, which are controlled by signals from the controller 3, respectively, are connected. Incidentally, although omitted from illustration, in this embodiment, each of the charging power source 73, the developing power source 74, the primary transfer power source 75, and the potential regulating power source 80 is provided independently of the associated image forming unit 10. In addition, to the controller 3, the temperature sensor 71, the humidity sensor 72, the voltage detecting sensor 75a and the current detecting sensor 75b of the primary transfer power source 75, the voltage detecting sensor 76a and the current detecting sensor 76b of the secondary transfer power source 76, and the fixing temperature sensor 77, and the like are connected. A signal (information) indicating a detection result of the associated sensor is inputted to the controller 3. Further, to the controller 3, an operating portion 70 is connected. Then operating portion 70 includes an input portion constituted by an operation button (key) or the like as an input means, and a display portion 70a constituted by a liquid crystal panel (display) or the like as display means. Incidentally, in this embodiment, the display portion 70a is constituted as a touch panel, and also has a function as the input means. An operator such as a user or a service person operates the operating portion 70 and thus can cause the image forming apparatus 1 to execute a job (a series of operations for forming and outputting an image on a single recording material S or images on a plurality of recording materials S by a single start instruction). The controller 3 receives the signal from the operating portion 70 and operates various devices of the image forming apparatus 1. In addition, the image forming apparatus 1 can also execute the job depending on the signal, for example, from the external device such as the personal computer, not from the operating portion 70.

### 3. Summary of Problem and Solution

Next, the problem in this embodiment will be described. Incidentally, for convenience, unless otherwise mentioned, a magnitude (high/low) of a voltage and a potential refers to a magnitude (high/low) in the case where values thereof are compared with each other in terms of an absolute value. Further, as regards arrangements of the primary transfer portion N1, the photosensitive drum 11, the primary transfer roller 15, and the potential regulating member 8 described later, and the like, unless otherwise mentioned, upstream and downstream refer to upstream and downstream with respect to the feeding direction (process progression direction, movement direction) of the intermediary transfer belt 6.

In the image forming apparatus 1 of the intermediary transfer type, it is difficult to uniformly transfer the toner image on, for example, embossed paper with surface unevenness. Incidentally, the embossed paper is paper (fancy paper) provided with an uneven pattern by using a method such as swelling or stamping on the surface of the paper. Particularly, transfer of the toner image onto a recessed portion of the embossed paper requires a relatively large transfer electric field because a gap is formed between the intermediary transfer belt 6 and the embossed paper in the secondary transfer portion N2, and thus is liable to become difficult. Further, when a secondary transfer electric field is made large for improving a transfer property of the toner image onto the recessed portion of the embossed paper, in the case where the transfer electric field becomes excessively large at a portion other than the recessed portion, there is a possibility that improper transfer such that the toner is not partially transferred onto a half-tone image occurs.

The toner on the intermediary transfer belt 6 is subjected to electric discharge between the intermediary transfer belt 6 and the photosensitive drum 11 on a side downstream of the primary transfer portion N1 and thus a charge amount of the toner increases. Specifically, the toner is subjected to the electric discharge and thus there is a tendency that an average of the charge amount of the toner is increased while a toner charge amount distribution becomes broader than a toner charge amount distribution during the development. In addition, the charge amount increases as described above, and therefore, a mirror force between the toner and the intermediary transfer belt 6 increases and a transfer electric field necessary to transfer the toner onto the recording material S in the secondary transfer portion N2 becomes large, and thus it becomes further difficult to transfer the toner image onto the recessed portion of the embossed paper.

A transfer property of the toner image onto the recording material S, such as the embossed paper, onto which transfer of the toner image is relatively difficult can be improved by suppressing the above-described electric discharge and the increase in charge amount of the toner on the intermediary transfer belt 6. In order to suppress the above-described electric discharge, it is effective that a potential difference between the photosensitive drum 11 and the intermediary transfer belt 6 after the toner image passes through the primary transfer portion N1 is made small. Further, for that purpose, it is effective that a potential regulating member 8 which is an electrode member is provided on an inner peripheral surface (back surface) side of the intermediary transfer belt 6 in a position downstream of the primary transfer portion N1 and that a voltage of the same polarity as the charge polarity of the photosensitive drum 11 is applied to the potential regulating member 8.

Further, the above-described electric discharge occurs in a range of about 0.3 to 1.5 mm from the primary transfer portion N1 toward a downstream side in many cases. On the other hand, it would be considered that by applying the voltage of the same polarity as the charge polarity of the photosensitive drum 11 to the potential regulating member 8, the above-described electric discharge can be suppressed by the action of an electric field formed in a space between the photosensitive drum 11 and the potential regulating member 8. Further, the above-described electric discharge suppressing effect is larger in the case where the potential regulating member 8 is surface-contacted to the intermediary transfer belt 6 with a width with respect to the feeding direction of the intermediary transfer belt 6 than in the case where the potential regulating member 8 is point (line)-contacted to the intermediary transfer belt 6 with respect to the feeding direction of the intermediary transfer belt 6. Accordingly, it is preferable that the potential regulating member 8 is surface-contacted to the intermediary transfer belt 6.

Here, the surface contact (contact at the surface) means that the contact does not include the case where the potential regulating member 6 is contacted to the intermediary transfer belt 6 only in a line shape with respect to a direction crossing the feeding direction of the intermediary transfer belt 6 in a range narrower than a width corresponding to a proximity width (about 5 to 50 mm) as described specifically hereinafter.

However, it was found that the following phenomenon occurs when the potential regulating member 8 contacts the inner peripheral surface of the intermediary transfer belt 6. That is, it was found that when the toner on the intermediary transfer belt 6 passes through a region corresponding to the potential regulating member 8, the toner is scattered by an electric field formed under application of a voltage (potential regulating voltage) of the same polarity as the charge polarity of the photosensitive drum 11 to the potential regulating member 8. The region corresponding to the potential regulating member 8 is specifically a region of the outer peripheral surface of the intermediary transfer belt 6, with respect to the feeding direction of the intermediary transfer belt 6, to which the potential regulating member 8 is contacted on the inner peripheral surface side of the intermediary transfer belt 6.

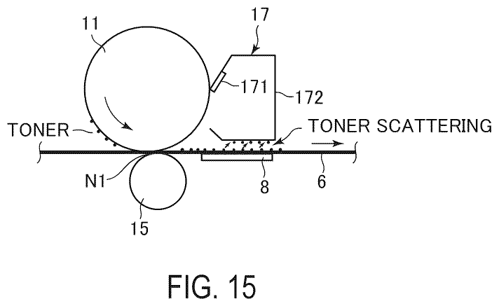

FIG. 15 is a schematic sectional view, of the neighborhood of the primary transfer portion N1, for illustrating the above-described toner scattering. As shown in FIG. 15, in the region corresponding to the potential regulating member 8, in some cases, elements or the like constituting the image forming unit 10 are disposed opposed to the outer peripheral surface (toner image bearing surface) of the intermediary transfer belt 6. In this embodiment, in the region corresponding to the potential regulating member 8, the drum cleaning device 17 is disposed opposed to the intermediary transfer belt 6. The drum cleaning device 17 is constituted by including, for example, cleaning member (cleaning blade) 171 and a cleaning container (collecting container) 172 for accommodating the toner removed from the photosensitive drum 11 by the cleaning member 171. In this case, when the toner scattering occurs, there is a possibility that the toner is deposited on an outside surface or the like of the cleaning container 172 opposing the outer peripheral surface of the intermediary transfer belt 6 and thus the cleaning container 172 is contaminated with the toner. Thus, when the toner scattering occurs, there is a possibility that the inside of the image forming apparatus is contaminated.

On the other hand, in this embodiment, the potential regulating member 8 is separated from the inner peripheral surface of the intermediary transfer belt 6.

By this, it was found that the above-described toner scattering can be alleviated. This would be considered for the following reason. In the case where the potential regulating member 8 contacts the inner peripheral surface of the intermediary transfer belt 6, when the potential regulating voltage is applied, a current flows from the potential regulating member 8 through the intermediary transfer belt 6. Then, a potential of the intermediary transfer belt 6 in the region corresponding to the potential regulating member 8 becomes a potential equal to the potential regulating voltage. The potential regulating voltage has the same polarity as the charge polarity of the photosensitive drum 11 and has the same polarity as the normal charge polarity of the toner. By this, an electric field which is formed in the region corresponding to the potential regulating member 8 between the intermediary transfer belt 6 and a member (the cleaning container 172 or the like) disposed opposed to the outer peripheral surface of the intermediary transfer belt 6 and which is in a direction in which the toner is moved toward the member becomes strong, so that the toner scattering is liable to occur. On the other hand, when the potential regulating member 8 is separated from the inner peripheral surface of the intermediary transfer belt 6, even under application of the potential regulating voltage to the potential regulating member 8, the current does not flow from the potential regulating member 8 through the intermediary transfer belt 6. By this, in the case where the potential regulating member 8 is separated from the inner peripheral surface of the intermediary transfer belt 6, compared with the case where the potential regulating member 8 is contacted to the inner peripheral surface of the intermediary transfer belt 6, a potential of the intermediary transfer belt 6 in the region corresponding to the potential regulating member 8 largely lowers. Accordingly, it becomes possible to largely lower strength of the electric field which is formed in the region corresponding to the potential regulating member 8 between the intermediary transfer belt 6 and the member (the cleaning container 172 or the like) disposed opposed to the outer peripheral surface of the intermediary transfer belt 6 and which is in the direction in which the toner is moved toward the member. On the other hand, depending on a distance or the like between the inner peripheral surface of the intermediary transfer belt 6 and the potential regulating member 8, an effect of suppressing the above-described electric discharge by the action of the electric field formed in the space between the photosensitive drum 11 and the potential regulating member 8 can be sufficiently maintained.

Here, according to study by the present inventors, also in the case where the potential regulating member 8 is separated from the inner peripheral surface of the intermediary transfer belt 6, similarly as in the case where the potential regulating member 8 is contacted to the inner peripheral surface of the intermediary transfer belt 6, it was found that in the feeding direction of the intermediary transfer belt 6, the above-described electric discharge suppressing effect is larger in the case where the potential regulating member 8 is brought near to the intermediary transfer belt 6 by a surface thereof with a width from the intermediary transfer belt 6 than in the case where the potential regulating member 8 is brought near to the intermediary transfer belt 6 by dots (dotted line) thereof. This is because also in the case where the potential regulating member 8 is separated from the inner peripheral surface of the intermediary transfer belt 6, similarly as in the case where the potential regulating member 8 is contacted to the inner peripheral surface of the intermediary transfer belt 6, the above-described electric discharge can be suppressed by the action of the electric field formed in the space between the photosensitive drum 11 and the potential regulating member 8. Here, “the potential regulating member 8 is brought near to the intermediary transfer belt 6 by a surface thereof” means that this expression does not include the case where the potential regulating member 8 is brought near to the intermediary transfer belt 6 only linearly in a direction crossing the feeding direction of the intermediary transfer belt 6 in a range narrower than a proximity width (about 5 to 50 mm) described later specifically. Accordingly, for example, the above-described expression includes not only the case where a substantially whole area of the potential regulating member 8 is uniformly close to the intermediary transfer belt 6 in a region of the proximity width described later specifically, but also the case where many proximity points are substantially uniformly distributed in the above-described range as in the case of a nonwoven fabric. In the following, description will be made further specifically.

### 4. Potential Regulating Member

Next, a constitution of the potential regulating member 8 in this embodiment will be described.

As shown in FIG. 1, the image forming apparatus 1 of this embodiment, on sides downstream of the primary transfer portions N1y, N1m, N1c, and N1k, the potential regulating members 8y, 8m, 8c, and 8k which are electrode members are provided, respectively, in proximity to the inner peripheral surface of the intermediary transfer belt 6. In this embodiment, the potential regulating members 8y, 8m, 8c, and 8k provided in the primary transfer portions N1y, N1m, N1c, and N1k have the substantially same constitution.

A shape of the potential regulating member 8 in this embodiment will be described. Part (a) of FIG. 3 is a schematic sectional view (cross section substantially perpendicular to a rotational axis direction of the photosensitive drum 11) of the potential regulating member 8 in this embodiment, and part (b) of FIG. 3 is a schematic perspective view of the potential regulating member 8.

In this embodiment, the potential regulating member 8 includes a planar first portion 81 provided along a widthwise direction (direction substantially perpendicular to the feeding direction, direction substantially parallel to the rotational axis direction of the photosensitive drum 11) of the intermediary transfer belt 6. Further, in this embodiment, the potential regulating member 8 includes a planar second portion 82 provided along the widthwise direction of the intermediary transfer belt 6 and extending in a direction crossing (in this embodiment, substantially perpendicular to) a flat surface of the first portion 81. In this embodiment, a surface of the first portion 81 of the potential regulating member 8 (the surface opposing the inner peripheral surface of the intermediary transfer belt 6) i.e., a proximity surface 83 which is a portion brought near to the inner peripheral surface of the intermediary transfer belt 6 is a flat surface. That is, in this embodiment, the first portion 81 constituting the proximity surface 83 of the potential regulating member 8 is a flat plate. Thus, in this embodiment, the potential regulating member 8 is constituted by a substantially L-shaped member in cross section substantially perpendicular to the rotational axis direction of the photosensitive drum 11.

Here, in the cross section substantially perpendicular to the rotational axis direction of the photosensitive drum 11, an upstream-side end portion of the proximity surface 83 is defined as “A (or upstream end A)”, and a downstream-side end portion of the proximity surface 83 is defined as “B (or downstream end B)”. In this embodiment, the upstream end A of the proximity surface 83 corresponds to an upstream-side end portion of the potential regulating member 8, and the downstream end B of the proximity surface 83 corresponds to a downstream-side end portion of the potential regulating member 8. As described above, by the action of the electric field formed in the space between the photosensitive drum 11 and the potential regulating member 8, in order to more effectively suppress the electric discharge between the intermediary transfer belt 6 and the photosensitive drum 11, the potential regulating member 8 may preferably be brought near to the intermediary transfer belt 6 by the surface thereof. From this viewpoint, a length of a line segment AB (between A and B), i.e., a “proximity width” which is a length of the proximity surface 83 in the feeding direction of the intermediary transfer belt 6 may preferably be 5 mm or more. With a longer length of the line segment AB, the above-described effect of suppressing the electric field becomes larger, but it would be considered that when the length becomes excessively long, appropriate setting of a distance between the potential regulating member 8 and the intermediary transfer belt 6 becomes difficult by the influence of (component) part accuracy or the like. The length of the line segment AB is sufficient in many cases when the length is 50 mm or less, and typically is 30 mm or less. That is, the length of the line segment AB may suitably be about 5 to 50 mm, typically about 5 to 30 mm. From another viewpoint, it can be said that the length of the line segment AB is enough to be not more than a half of a center distance between adjacent photosensitive drums 11 in a cross section substantially perpendicular to the rotational axis direction of the photosensitive drum 11 in many cases. In this embodiment, the potential regulating member 8 which is 25 mm in length of the line segment AB is used. Incidentally, in this embodiment, the center distance between the photosensitive drums 11 in the cross section substantially perpendicular to the rotational axis direction of the photosensitive drum 11 is about 100 mm.

To the potential regulating member 8, the potential regulating power source 80 as a potential regulating voltage applying means (potential regulating voltage applying portion) is connected. In this embodiment, to the second portion 82 of the potential regulating member 8, the potential regulating power source 80 is connected. At least at the time of the primary transfer during the image forming operation, to the potential regulating member 8, a potential regulating voltage (potential regulating bias) which is a DC voltage of the same polarity as the charge polarity of the photosensitive drum 11 is applied by the potential regulating power source 80. The time of the primary transfer is specifically a period in which the primary transfer voltage is applied, more specifically, a period in which an image region (region onto which the toner image is capable of being transferred) on the intermediary transfer belt 6 passes through the primary transfer portion N1. By this, it is possible to suppress the electric discharge between the intermediary transfer belt 6 and the photosensitive drum 11 on a side downstream of the primary transfer portion N1. In this embodiment, the potential regulating voltage is a DC voltage of a negative polarity. Further, in the constitution of this embodiment, the potential regulating voltage may preferably be about −500 to −8000 V, more preferably be about −1000 to −5000 V, typically about −1000 to −3000 V.

The potential regulating member 8 is a member long in the widthwise direction of the intermediary transfer belt 6. A length of the proximity surface 83 of the potential regulating member 8 in a longitudinal direction (direction along the widthwise direction of the intermediary transfer belt 6 may preferably be longer than a maximum image width in the widthwise direction of the intermediary transfer belt 6. Incidentally, the maximum image width is a length of an image region of a maximum image capable of being formed by the image forming apparatus 1 with respect to the widthwise direction of the intermediary transfer belt 6. In this embodiment, the length of the proximity surface 83 of the potential regulating member 8 in the longitudinal direction is longer than the above-described maximum image width and a width of a portion in which the primary transfer roller 15 contacts the intermediary transfer belt 6 with respect to the widthwise direction of the intermediary transfer belt 6. That is, in this embodiment, each of a range of the maximum image width and a range of the width of the portion in which the primary transfer roller 15 contacts the intermediary transfer belt 6 with respect to the widthwise direction of the intermediary transfer belt 6 falls inside a range of the length of the proximity surface 83 of the potential regulating member 8 in the longitudinal direction. By this, irrespective of a length of the toner image, transferred onto the intermediary transfer belt 6, with respect to the widthwise direction of the intermediary transfer belt 6, it is possible to obtain an effect of suppressing an increase in charge amount of the toner on the intermediary transfer belt 6 by suppressing the above-described electric charge. On the other hand, in this embodiment, the length of the potential regulating member 8 in the longitudinal direction is shorter than the width of the intermediary transfer belt 6. That is, in this embodiment, the range of the length of the potential regulating member 8 in the longitudinal direction falls inside the range of the width of the intermediary transfer belt 6. By this, it is possible to suppress the electric discharge, between the potential regulating member 8 and a peripheral member or the like of the intermediary transfer belt 6, capable of occurring in the case where an end portion of the potential regulating member 8 with respect to the longitudinal direction protrudes than an end portion of the intermediary transfer belt 6 with respect to the widthwise direction is. As a result, it is possible to reduce a possibility that the effect of suppressing the electrical discharge between the intermediary transfer belt 6 and the photosensitive drum 11 by the potential regulating member 8 becomes small.

The potential regulating member 8 can be constituted only by, for example, a single material having electroconductivity. In this embodiment, the potential regulating member 8 is constituted substantially only by metal having electroconductivity, such as SUS (stainless steel). Specifically, in this embodiment, the potential regulating member 8 is constituted by forming the first portion 81 and the second portion 82 by subjecting a plate material made of metal (metal plate) such as SUS to bending. A thickness of the metal plate used for the potential regulating member 8 may be, for example, about 0.5 to 5 mm, typically is about 1 to 3 mm. By thus subjecting the metal plate to the bending, strength of the potential regulating member 8 can be increased. In this embodiment, each of the first portion 81 and the second portion 82 of the potential regulating member 8 is not substantially deformed in a use state of the image forming apparatus 1. However, the present disclosure is not limited to such an embodiment, but the potential regulating member 8 may also be constituted by two or more materials.

Incidentally, the electroconductive material (electroconductor) refers to a material (substance) of which resistivity is about 10⁻⁶ Ω.cm or less, typically about 10⁻⁸ Ω.m. Further, a non-electroconductive material (insulator) refers to a material (substance) of which resistance value is 10⁸ Ω.m or more, preferably 10¹⁰ Ω.m or more. However, the insulator is 10¹⁶ Ω.m or less in resistivity.

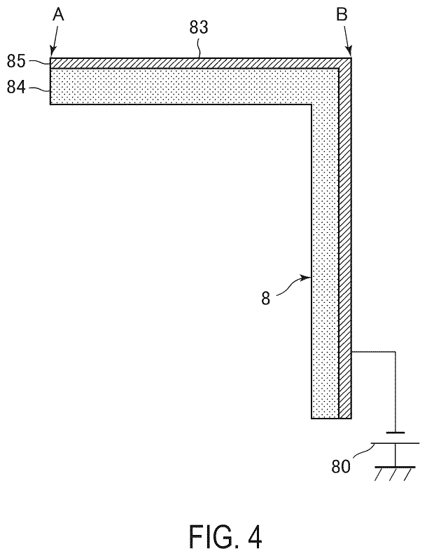

FIG. 4 is a schematic sectional view (cross section substantially perpendicular to the rotational axis direction of the photosensitive drum 11) in another example of the potential regulating member 8. For example, as shown in FIG. 4, a constitution in which a base portion 84 having a shape similar to the shape of the potential regulating member 8 shown in FIG. 3 and a surface layer 85 formed on the base portion 84 are provided can be employed. The proximity surface 83 brought near to the intermediary transfer belt 6 and the surface layer 85 constituting a connecting portion with the potential regulating power source 80 are formed of an electroconductive material such as metal or an electroconductive resin material.

The surface layer 85 may also have a constitution which is the same constitution as the constitution of the potential regulating member 8 shown in FIG. 3. The base portion 84 may be formed of the electroconductive material, but may also be formed of a non-electroconductive (electrically insulative) material, for example, a non-electroconductive resin material. The base portion 84 and the surface layer 85 can be fixed by an arbitrary fixing means such as bonding with an adhesive or welding.

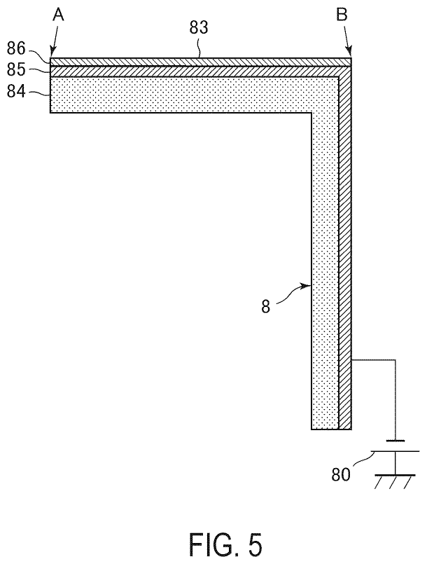

Further, FIG. 5 is a schematic sectional view (cross section substantially perpendicular to the rotational axis direction of the photosensitive drum 11) in still another example of the potential regulating member 8. For example, as shown in FIG. 5, the proximity surface 83 of the potential regulating member 8 brought near to the intermediary transfer belt 6 may also be formed of an electroconductive nonwoven fabric 86. Incidentally, in an example shown in FIG. 5, the electroconductive nonwoven fabric 86 is provided on the proximity surface 83 of the potential regulating member 8 having the constitution shown in FIG. 4, but the electroconductive nonwoven fabric 86 may also be provided on the proximity surface 83 of the potential regulating member 8 having the constitution shown in FIG. 3. That is, the potential regulating member 8 may be formed by using other materials for the base portion to which the voltage is applied and the surface layer brought near to the inner peripheral surface of the intermediary transfer belt 6. The electroconductive nonwoven fabric 86 can be fixed by an arbitrary fixing means such as an electroconductive adhesive. Further, instead of the electroconductive nonwoven fabric 86, a felt, a pile fabric (cut pile fabric (velvet, brush) or loop pile fabric (toweling)) which are constituted using electroconductive fibers, or a sponge (elastic foam member) constituted using an electroconductive rubber material may also be used.

### 5. Arrangement of Potential Regulating Member

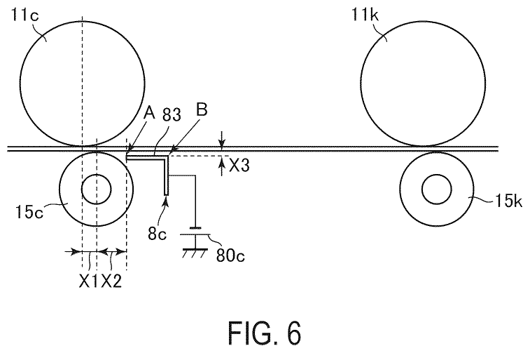

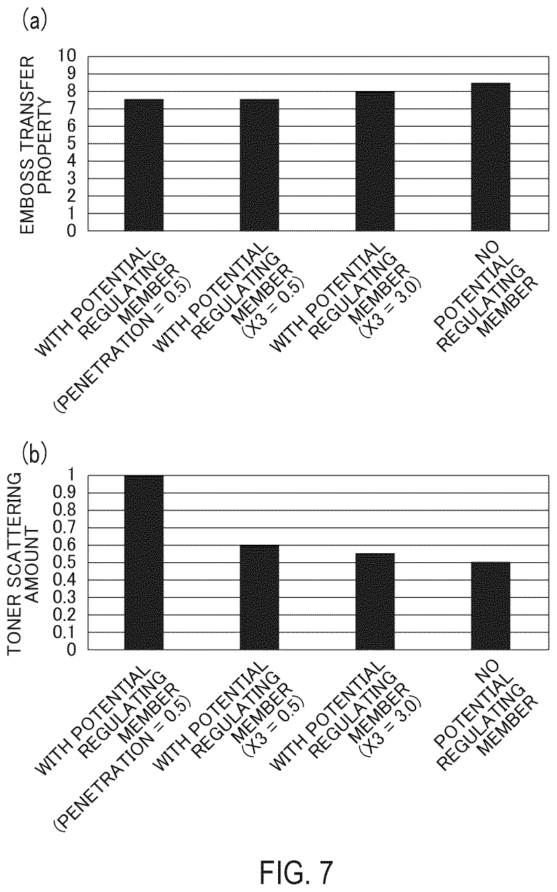

Next, an arrangement of the potential regulating member 8 in this embodiment will be described. In this embodiment, the arrangement of the potential regulating member 8 provided and disposed for each of the primary transfer portions N1y, N1m, N1c, and N1k is substantially the same. FIG. 6 is a schematic sectional view (cross section substantially perpendicular to the rotational axis direction of the photosensitive drum 11) for illustrating the arrangement of the potential regulating member 8 provided between two primary transfer portions N1 adjacent to each other in the feeding direction of the intermediary transfer belt 6. In FIG. 6, as an example, a potential regulating member 8c provided between the primary transfer portions N1c for cyan and N1k for black is shown.

In this embodiment, an outer diameter of the photosensitive drum 11 is 30 mm, an outer diameter of the primary transfer roller 15 is 18 mm, and a thickness of the intermediary transfer belt 6 is 0.350 mm. Further, in this embodiment, the primary transfer roller 15 is offset toward a downstream side relative to the photosensitive drum 11. In this embodiment, an offset amount X1 is 3 mm. Incidentally, the offset amount X1 is a distance between a rotation center of the photosensitive drum 11 and a rotation thereof an associated primary transfer roller 15 in a direction along (substantially parallel to) a common tangential line on a side where a plurality of photosensitive drums 11 contact the intermediary transfer belt 6 in a cross section substantially perpendicular to the rotational axis direction of the photosensitive drum 11. Further, the primary transfer roller 15 may be disposed without being offset relative to the photosensitive drum 11 and may also be disposed so as to be offset toward an upstream side relative to the photosensitive drum 11.

As shown in FIG. 6, the potential regulating member 8 is disposed close to the primary transfer portion N1 on a side downstream of the primary transfer portion N1 so as not to contact the primary transfer roller 15 and the intermediary transfer belt 6. That is, when the potential regulating member 8 is positioned in an operating position where the potential regulating member 8 operates, the potential regulating member 8 is disposed so as not to contact the intermediary transfer belt 6. At this time, as the upstream end A is closer to the primary transfer portion N1, the effect of suppressing the electric charge between the intermediary transfer belt 6 and the photosensitive drum 11 by the potential regulating member 8 becomes larger. In this embodiment (FIG. 6), the potential regulating member x 8 is disposed in a position downstream of the primary transfer portion N1 so that a distance X2 from the primary transfer roller 15 to the upstream end A becomes about 8 mm. Here, the distance X2 is a distance between the rotation center of the primary transfer roller 15 and the upstream end A in a direction along (substantially parallel to) the common tangential line on a side where the plurality of photosensitive drums 11 contact the intermediary transfer belt 6 in the cross section substantially perpendicular to the rotational axis direction of the photosensitive drum 11.

That is, in this embodiment, the distance from the rotation center of the primary transfer roller 15 to the upstream end A is shorter than a distance (radius) from the rotation center of the primary transfer roller 15 to an outer circumference of the primary transfer roller 15. This distance is not limited thereto, but the above-described distance X2 may preferably be about 1 to 20 mm, typically about 1 to 10 mm.

In this embodiment, the potential regulating member 8 is disposed so that the proximity surface 83 is substantially parallel to the inner peripheral surface of the intermediary transfer belt 6. A distance between the inner peripheral surface of the intermediary transfer belt 6 and the proximity surface 83 (herein, this distance is also referred to as a “separation distance”) X3 is closer, the electric discharge between the intermediary transfer belt 6 and the photosensitive drum 11 can be suppressed more effectively. However, as described above, when the potential regulating member 8 contacts the inner peripheral surface of the intermediary transfer belt 6, a risk of the toner scattering becomes high. In this embodiment, the separation distance X3 is 1 mm. The separation distance X3 is not limited thereto, but the separation distance X3 may suitably be about 0.5 to 3.0 mm, typically about 0.5 to 1.5 mm.

Incidentally, the separation distance X3 can be represented by a value thereof in a state in which a stretching state of the intermediary transfer belt 6 is an image formable stretching state (in which primary transfer of the toner image from the photosensitive drum 11 onto the intermediary transfer belt 6 is possible) and in which the intermediary transfer belt 6 is at rest (stationary). During the image forming operation (during travelling of the intermediary transfer belt 6), waving and vibration occur on the intermediary transfer belt 6 in some instances, so that there is a possibility that the separation distance X3 changes (for example, change of less than ±0.5 mm). The potential regulating member 8 may desirably be separated from the inner peripheral surface of the intermediary transfer belt 6 preferably in the separation distance X3 of the above-described range also during the image forming operation (during the traveling of the intermediary transfer belt 6). However, during the image forming operation (during the traveling of the intermediary transfer belt 6), the potential regulating member 8 may also be contacted, for example, temporarily to the inner peripheral surface of the intermediary transfer belt 6. As described above, as regards the above-described electric discharge suppressing effect, there is no problem in that the potential regulating member 8 contacts the intermediary transfer belt 6. Further, also, as regards a toner scattering suppressing effect, unless the potential regulating member 8 substantially always contacts the inner peripheral surface of the intermediary transfer belt 6, for example, even when the potential regulating member 8 temporarily contacts the inner peripheral surface of the intermediary transfer belt 6, the toner scattering suppressing effect can be obtained correspondingly.

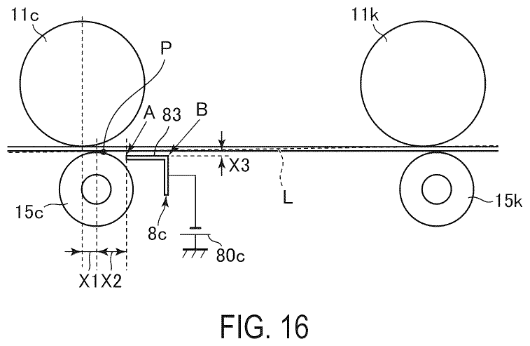

The arrangement of the potential regulating member 8 will be further described. FIG. 16 is a sectional view (cross section substantially perpendicular to the rotational axis direction of the photosensitive drum 11) for specifically illustrating the arrangement of the potential regulating member 8 provided between adjacent two primary transfer portions N1 with respect to the feeding direction of the intermediary transfer belt 6. In FIG. 16, as an example, the potential regulating member 8c provided between the primary transfer portions N1c and N1k for cyan and black. Incidentally, the photosensitive drum 11c for cyan and the primary transfer roller 15c for cyan are an example of a first photosensitive member and an example of a first transfer member, respectively. Further, the photosensitive drum 11k for black and the primary transfer roller 15k for black are an example of a second photosensitive member and an example of a second transfer member, respectively.

In the case where the members shown in FIG. 16 are viewed substantially parallel to the widthwise direction of the intermediary transfer belt 6, a tangential line which is a tangential line of the photosensitive drum 11k for black passing through a point P being a position P as a downstream end of a contact portion, where the primary transfer roller 15c for cyan and the intermediary transfer belt 6 are in contact with each other, with respect to the feeding direction of the intermediary transfer belt 6 and which passes through a side where the intermediary transfer belt 6 is disposed is defined as a rectilinear line L. At this time, during the image formation, the potential regulating member 8 is provided is a position which is a position on a side opposite from the photosensitive drum 11k for black with respect to the rectilinear line L and which is separated (spaced) from the rectilinear line L. The separation distance X3 can be represented by a distance (shortest distance) between the rectilinear line L and the potential regulating member 8 (proximity surface 83). As described above, this separation distance X3 may suitably be about 0.5 to 3.0 mm, typically about 0.5 to 1.5 mm.

### 6. Effect Confirmation

Next, a result in which an effect of this embodiment is verified will be described. This verification was performed for two points as to whether or not a transfer property of the toner image onto the embossed paper is improved and as to whether or not the toner scattering occurs to which degree. Further, as the verification of the two points, comparisons as to the following four conditions (states) were performed.

A first state is a state in which the potential regulating members 8 (8m, 8c, 8k) are removed from the image forming apparatus 1 (hereinafter, this state is referred to as “no potential regulating member”).

A second state is a state in which the potential regulating members 8 (8m, 8c, 8k) are mounted in the image forming apparatus 1 and are contacted (surface-contacted) which being penetrated into the inner peripheral surface of the intermediary transfer belt 6 so that a penetration (entering) amount becomes 0.5 mm and in which a potential regulating voltage of −3000 V is applied to the potential regulating members 8 by the potential regulating power source 80 (hereinafter, this state is referred to as “with potential regulating member (penetration=0.5)”. Here, the penetration amount in which a surface corresponding to the proximity surface 83 of the potential regulating member 8 in this embodiment penetrates enters toward the photosensitive drum 11 side with respect to a rectilinear line through which a stretching surface of the intermediary transfer belt on the inner peripheral surface side in a region downstream of the primary transfer portion N1 in the case where there is no potential regulating member 8.

A third state is a state in which the potential regulating members 8 (8m, 8c, 8k) are mounted in the image forming apparatus 1 and are separated from the inner peripheral surface of the intermediary transfer belt 6 so that the separation distance X3 becomes 0.5 mm and in which the potential regulating voltage of −3000 V is applied to the potential regulating members 8 by the potential regulating power source 80 (hereinafter, this state is referred to as “with potential regulating member (X3=0.5 mm)”.

A fourth state is a state in which the potential regulating members 8 (8m, 8c, 8k) are mounted in the image forming apparatus 1 and are separated from the inner peripheral surface of the intermediary transfer belt 6 so that the separation distance X3 becomes 3.0 mm and in which the potential regulating voltage of −3000 V is applied to the potential regulating members 8 by the potential regulating power source 80 (hereinafter, this state is referred to as “with potential regulating member (X3=3.0 mm)”.

Incidentally, in either of the cases of the “with potential regulating member (X3=0.5)” and the “with potential regulating member (X3=3.0)”, the distance X2 from the primary transfer roller 15 to the upstream end A was 8 mm.

Further, the conditions of the “width potential regulating member (penetration=0.5)”, the “with potential regulating member (X3=0.5)”, and the “width potential regulating member (X3=3.0)” and also collectively referred to as “with potential regulating member”.

As regards the transfer property to the embossed paper, the following experiment was conducted. In the image forming apparatus 1 according to this embodiment, a width of the primary transfer portion N1 (a length of the intermediary transfer belt 6 in the widthwise direction) was 330 mm, and a width of the secondary transfer portion N2 (a length of the intermediary transfer belt 6 in the widthwise direction) was 340 mm. Further, this image forming apparatus 1 was operated at a process speed (peripheral speed of the photosensitive drum 11) of 180 mm/sec. Further, A4-size toner images which are solid images were formed on the photosensitive drum 11m for magenta and the photosensitive drum 11c for cyan, and the toner images were primarily transferred superposedly in the order of the toner image for magenta and the toner image for cyan. Thereafter, the toner images were conveyed by the intermediary transfer belt 6 and passed through the primary transfer portion N1k for black, and then the toner images were secondarily transferred in the secondary transfer portion N2. Further, the toner images were fixed on the embossed paper by the fixing device 27.

By this, on the embossed paper, a solid blue image was formed on the embossed paper. By the controller 3, the primary transfer voltage was subjected to constant-voltage control by a voltage set so that a primary transfer current in the primary transfer portion N1 becames 20 μA which is a target current. Further, by the controller 3, the secondary transfer voltage was subjected to constant-voltage control by a voltage set so that a secondary transfer current in the secondary transfer portion N2 became 30 μA which is a target current. As the embossed paper, “LEATHAC 66” (manufactured by Tokushu Tokai Paper Co., Ltd., trade name) having a basis weight of 302 g/m² was used. Further, images on the embossed paper in the respective conditions were compared with each other, and whether or not the toner was capable of being transferred on a recessed portion of the embossed paper was evaluated by being converted into numerical values. For conversion of the transfer property to the embossed paper, a method in which RGB brightness data (8 bit) of the solid blue image is acquired at 600 dpi by a scanner device (image reading device and a standard deviation of filter B brightness data in a solid blue image region is calculated was used. With a higher degree of the transfer of the toner onto the recessed portion of the embossed paper, brightness unevenness in the solid blue image is less and the standard deviation becomes smaller.

As regards the toner scattering, the following experiment was conducted. The image forming apparatus 1 in which the transfer property to the embossed paper was evaluated was operated at a process speed (peripheral speed of the photosensitive drum 11) of 360 mm/s, and after formation of images on 500 sheets, a toner deposition amount in a position of the drum cleaning device 17 opposing the intermediary transfer belt 6 was evaluated. A specific image forming condition is as follows. On the photosensitive drum 11c for cyan, an A4-size toner image which is a solid image was formed, and the toner image was primarily transferred onto the intermediary transfer belt 6 in the primary transfer portion N1c for cyan. Thereafter, the toner image was conveyed by the intermediary transfer belt 6 and passed through the primary transfer portion N1k for black, and then was secondarily transferred onto plain paper having a basis weight of 80 gsm. By the controller 3, the primary transfer voltage was subjected to constant-voltage control by a voltage set so that a primary transfer current in the primary transfer portion N1 became 40 μA which is a target current. Further, by the controller 3, the secondary transfer voltage was subjected to constant-voltage control by a voltage set so that a secondary transfer current in the secondary transfer portion N2 became 60 μA which is a target current. The toner deposition amount was evaluated in a manner such that the toner in the position of the drum cleaning device 17 for cyan was sampled with a transparent adhesive tape and the adhesive tape was applied to white paper and then that a density (optical density) of the sampled toner was measured by a reflection densitometer. The toner deposition amounts in the respective conditions were represented by relative amounts when the toner deposition amount in the case of the “with potential regulating member (penetration=0.5)”is taken as 1.

Evaluation results are shown in parts (a) and (b) of FIG. 7. Part (a) of FIG. 7 shows the evaluation result of the transfer property to the embossed paper, and part (b) of FIG. 7 shows the evaluation result of the toner scattering.

The transfer property to the embossed paper is better (smaller in standard deviation) in the case of the “with potential regulating member” than in the case of the “no potential regulating member”. Further, the transfer property to the embossed paper is better in the cases of the “with potential regulating member (penetration=0.5) and the ”with potential regulating member (X3=0.5) than in the case of the “with potential regulating member (X3=3.0)”. Further, the transfer property to the embossed paper is comparable between the cases of the “with potential regulating member (penetration=0.5)” and the “with potential regulating member (X3=0.5)”. In this embodiment, a target value of the transfer property to the embossed paper was taken as 8 or less in terms of the standard deviation. By satisfying this target value, a good image can be formed on the embossed paper. In order to satisfy this target value, the separation distance X3 may preferably be 3.0 mm or less.

The toner scattering is smaller in amount in the case of the “no potential regulating member” than in the case of “with potential regulating member”.

Further, in the case of the “with potential regulating member”, the toner scattering becomes smaller in the order of the cases of the “with potential regulating member (penetration=0.5)”, the “with potential regulating member (X3=0.5), and the “with potential regulating member (X3=3.0)”. That is, the evaluation result of the toner scattering is better when the potential regulating member 8 is more separated from the intermediary transfer belt 6 and is more improved with an increasing separation distance X3. In this embodiment, a target value of the toner scattering was made 0.6 or less. By satisfying this target value, the toner scattering can be sufficiently suppressed. In order to satisfy this target value, the separation distance X3 may preferably be 0.5 mm or more.

Accordingly, in order to improve the transfer property to the embossed paper while suppressing the toner scattering, the separation distance X3 may suitably be about 0.5 to 3.0 mm.

Incidentally, in this embodiment, as the recording material S relatively difficult in transfer of the toner image thereon, the embossed paper was cited as an example, but a similar effect can be expected also on a recording material relatively high in electric resistance (high-resistance paper), such as synthetic paper or a resin film, which principally comprises a synthetic resin material.

As described above, according to this embodiment, it becomes possible to improve the transfer property to the recording material S such as the embossed paper relatively difficult in transfer of the toner image thereon while alleviating the toner scattering.

Further, by bringing the potential regulating member 8 into in non-contact with the intermediary transfer belt 6, an effect such that a risk of damaging the intermediary transfer belt 6 by friction can be alleviated can also be expected.

### Embodiment 2

Next, another embodiment of the present disclosure will be described. The basic structure and operation of an image forming apparatus of this embodiment are the same as those of the image forming apparatus of the embodiment 1. Therefore, in the image forming apparatus of this embodiment, elements having the same or corresponding functions or structures as those of the image forming apparatus of the embodiment 1 are denoted by the same reference numerals or symbols as those of the embodiment 1, and detailed description thereof will be omitted.

### 1. Potential Regulating Member and Distance Regulating Member

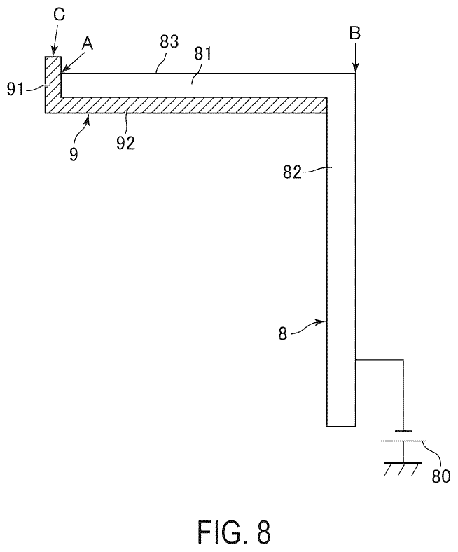

A constitution of a potential regulating member 8 in this embodiment will be described. FIG. 8 is a schematic sectional view (cross section substantially perpendicular to a rotational axis direction of the photosensitive drum 11) showing the potential regulating member 8 in this embodiment and a distance regulating member 9, described later, in this embodiment.

In this embodiment, the constitution of the potential regulating member 8 is the same as the constitution of the potential regulating member 8 shown in FIG. 3 described in the embodiment 1. That is, in this embodiment, the potential regulating member 8 includes the planar first portion 81, the planar second portion 82, and the proximity surface 83 which is a portion of the first portion 81 brought near to the inner peripheral surface of the intermediary transfer belt 6 is a flat surface. Further, in this embodiment, a size (a length of a line segment AB and a length in a longitudinal direction) of the proximity surface 83 of the potential regulating member 8 and a potential regulating voltage are the same as those in the embodiment 1. Further, in this embodiment, the potential regulating member 8 is constituted by substantially only the electroconductive metal such as SUS (stainless steel). However, the present disclosure is not limited to such an embodiment, but the potential regulating member 8 may also be constituted by two or more materials.

For example, as described in the embodiment 1 with reference to FIGS. 4 and 5, the proximity surface 83 of the potential regulating member 8 can be constituted by an electroconductive material, which is for example, metal, electroconductive resin, electroconductive nonwoven fabric, electroconductive fibers, or the like. Further, as regards the potential regulating member 8, the base portion, thereof to which a voltage is applied and the surface layer thereof brought near to the inner peripheral surface of the intermediary transfer belt 6 may also be formed of other materials.

Further, in this embodiment, the image forming apparatus 1 includes the distance regulating member 9 for regulating a distance between the potential regulating member 8 and the intermediary transfer belt 6. In this embodiment, the distance regulating member 9 is fixedly provided to the potential regulating member 8. In this embodiment, the distance regulating member 9 includes an upstream projected portion (projection portion) C projected toward the inner peripheral surface side of the intermediary transfer belt 6 relative to the proximity surface 83 along a direction crossing (in this embodiment, substantially perpendicular to) the proximity surface 83 of the potential regulating member 8 on a side upstream of an upstream end A of the potential regulating member 8.

In this embodiment, the distance regulating member 9 is disposed on the side upstream of the upstream end A of the potential regulating member 8 and includes a distance regulating portion 91 provided with the upstream projected portion C and a supporting portion 92 disposed along a surface of the first portion 81 of the potential regulating member 8 on a side opposite from the proximity surface 83. In this embodiment, the distance regulating portion 91 is disposed along the widthwise direction of the intermediary transfer belt 6 and is constituted by a planar member extending in a direction substantially perpendicular to the first portion 81 of the potential regulating member 8. Further, in this embodiment, the supporting portion 92 is disposed along the widthwise direction of the intermediary transfer belt 6 and is constituted by a planar member extending in a direction substantially perpendicular to a flat surface of the distance regulating portion 91. Further, in this embodiment, the distance regulating member 9 is prepared by integrally constituting the distance regulating portion 91 and the supporting portion 92 with each other. That is, in this embodiment, the distance regulating member 9 is constituted by a substantially L character-shaped member in cross section substantially perpendicular to the rotational axis direction of the photosensitive drum 11. The distance regulating member 9 is provided so that the distance regulating portion 91 contacts an upstream-side end surface of the first portion 81 of the potential regulating member 8 and the supporting portion 92 contacts the surface of the first portion 81 of the potential regulating member 8 on the side opposite from the proximity surface 83.

Incidentally, the distance regulating member 9 may also function as a supporting member for supporting the potential regulating member 8. Further, the distance regulating member 9 may also be pressed against the inner peripheral surface of the intermediary transfer belt 6 by an urging member (for example, pressing spring constituted by a compression coil spring) as an urging means, for example, in opposite end portions of a longitudinal direction thereof. By this, even in the case where waving and vibration occur on the intermediary transfer belt during the image forming operation (during the traveling of the intermediary transfer belt 6, the separation distance X3 can be more stabilized.

The distance regulating member 9 (the distance regulating portion 91, the supporting portion 92) is constituted by a non-electroconductive material, which is for example, a non-electroconductive resin or the like. In this embodiment, the distance regulating member 9 (the distance regulating portion 91, the supporting portion 92) is constituted by non-electroconductive POM (polyacetal resin). Further, in this embodiment, the distance regulating member 9 is constituted so that the distance regulating portion 91 and the supporting portion 92 extend over a whole region of the first portion 91 (proximity surface 83) of the potential regulating member 8 with respect to the longitudinal direction thereof (the widthwise direction of the intermediary transfer belt 6). That is, in this embodiment, a length of each of the distance regulating portion 91 and the supporting portion 92 of the distance regulating member 9 in the longitudinal direction is made not less than a length of the first portion 81 (proximity surface 83) of the potential regulating member 8 in the longitudinal direction. That is, in this embodiment, a length range of the potential regulating member 8 in the longitudinal direction is the same as or falls inside a length range of the distance regulating member 9 in the longitudinal direction. Further, in this embodiment, the upstream projected portion C of the distance regulating member 9 is projected toward the inner peripheral surface side of the intermediary transfer belt 6 by 0.5 mm relative to the proximity surface 83 along the direction substantially perpendicular to the proximity surface 83 of the potential regulating member 8.

### 2. Arrangement of Potential Regulating Member and Distance Regulating Member

Next, an arrangement of the potential regulating member 8 and the distance regulating member 9 in this embodiment will be described. Incidentally, in this embodiment, on a side downstream of the primary transfer portions N1, N1m, N1c, and N1k, the potential regulating members 8 (8y, 8m, 8c, 8k) and the distance regulating members 9 (9y, 9m, 9c, 9k) are disposed, respectively. In this embodiment, the constitutions and the arrangements of the potential regulating member 8 and the distance regulating member 9 provided and disposed for each of the primary transfer portions N1y, N1m, N1c, and N1k are substantially the same.

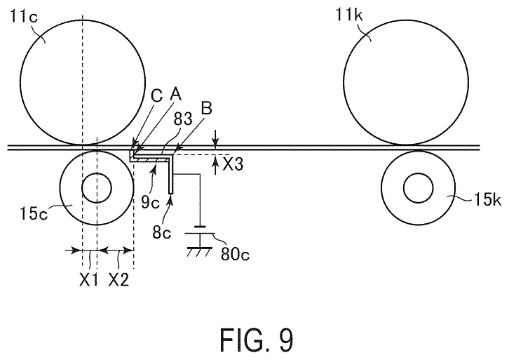

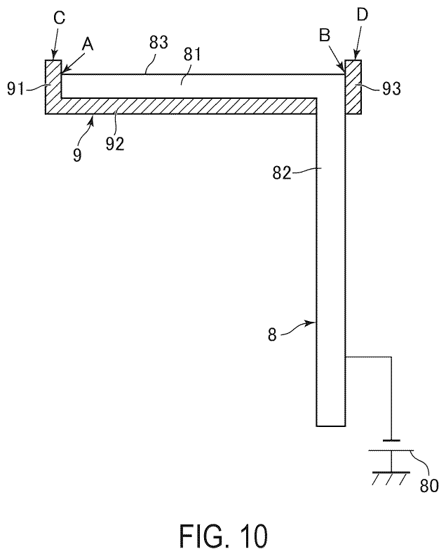

FIG. 9 is a schematic sectional view (cross section substantially perpendicular to the rotational axis direction of the photosensitive drum 11) for illustrating the arrangements of the potential regulating member 8 and the distance regulating member 9 provided between two primary transfer portions N1 adjacent to each other in the feeding direction of the intermediary transfer belt 6. In FIG. 9, as an example, a potential regulating member 8c and the distance regulating member 9c provided between the primary transfer portions N1c for cyan and N1k for black is shown.

In this embodiment, an outer diameter of the photosensitive drum 11, an outer diameter of the primary transfer roller 15, a thickness of the intermediary transfer belt 6, and the offset amount X1 are the same as those in the embodiment 1.

As shown in FIG. 9, the distance regulating member 9 is disposed close to the primary transfer portion N1 on a side downstream of the primary transfer portion N1 so as not to contact the primary transfer roller 15 and so that the upstream projected portion C contacts the inner peripheral surface of the intermediary transfer belt 6. The distance regulating member 9 is contacted to the inner peripheral surface of the intermediary transfer belt 6 at least in a state in which the stretching state of the intermediary transfer belt 6 is the image formable stretching surface and in which the intermediary transfer belt 6 is at rest (stationary). In this embodiment, the distance regulating member 9 is substantially always contacted to the inner peripheral surface of the intermediary transfer belt 6 also during the image forming operation (during the traveling of the intermediary transfer belt 6). Further, in this embodiment, similarly as in the embodiment 1, the potential regulating member 8 is disposed close to the primary transfer portion N1 on the side downstream of the primary transfer portion N1 so as not to contact the primary transfer roller 15 and the intermediary transfer belt 6. In this embodiment, the potential regulating member 8 is disposed in a position downstream of the primary transfer portion N1 so that a distance X2 from the primary transfer roller 15 to the upstream end A becomes about 10 mm. As described in the embodiment 1, this distance is not limited thereto, but the above-described distance X2 may preferably be about 1 to 20 mm, typically about 1 to 10 mm.

In this embodiment, similarly as in the embodiment 1, the potential regulating member 8 is disposed so that the proximity surface 83 is substantially parallel to the inner peripheral surface of the intermediary transfer belt 6. the separation distance X3 is regulated by bringing the upstream projected portion C of the distance regulating member 9 into contact with the inner peripheral surface of the intermediary transfer belt 6, and becomes 0.5 mm. By providing the distance regulating member 9, the separation distance X3 is stabilized. As described in the embodiment 1, the separation distance X3 is not limited thereto, but the separation distance X3 may suitably be about 0.5 to 3.0 mm, typically about 0.5 to 1.5 mm.

As described above, according to this embodiment, an effect similar to the effect of the embodiment 1 can be obtained, and in addition, the distance between the intermediary transfer belt 6 and the proximity surface 83 of the potential regulating member 8 can be stabilized.

### Embodiment 3

Next, another embodiment of the present disclosure will be described. The basic structure and operation of an image forming apparatus of this embodiment are the same as those of the image forming apparatuses of the embodiments 1 and 2. Therefore, in the image forming apparatus of this embodiment, elements having the same or corresponding functions or structures as those of the image forming apparatuses of the embodiments 1 and 2 are denoted by the same reference numerals or symbols as those of the embodiments 1 and 2, and detailed description thereof will be omitted.

### 1. Potential Regulating Member and Distance Regulating Member

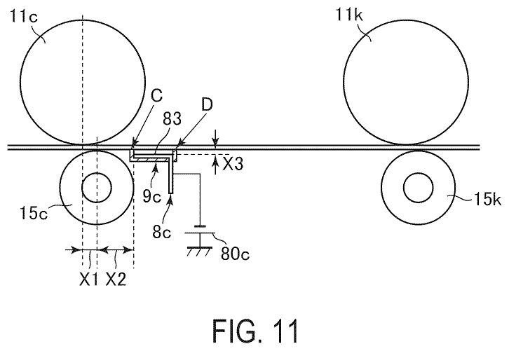

A constitution of a potential regulating member 8 in this embodiment will be described. FIG. 10 is a schematic sectional view (cross section substantially perpendicular to a rotational axis direction of the photosensitive drum 11) showing the potential regulating member 8 in this embodiment and a distance regulating member 9, described later, in this embodiment.

In this embodiment, the constitution of the potential regulating member 8 is the same as the constitution of the potential regulating member 8 shown in FIG. 3 described in the embodiment 1 and the potential regulating member 8 shown in FIG. 8 described in the embodiment 2. That is, in this embodiment, the potential regulating member 8 includes the planar first portion 81, the planar second portion 82, and the proximity surface 83 which is a portion of the first portion 81 brought near to the inner peripheral surface of the intermediary transfer belt 6 is a flat surface. Further, in this embodiment, a size (a length of a line segment AB and a length in a longitudinal direction) of the proximity surface 83 of the potential regulating member 8 and a potential regulating voltage are the same as those in the embodiment 1. Further, in this embodiment, the potential regulating member 8 is constituted by substantially only the electroconductive metal such as SUS (stainless steel). However, the present disclosure is not limited to such an embodiment, but the potential regulating member 8 may also be constituted by two or more materials.

For example, as described in the embodiment 1 with reference to FIGS. 4 and 5, the proximity surface 83 of the potential regulating member 8 can be constituted by an electroconductive material, which is for example, metal, electroconductive resin, electroconductive nonwoven fabric, electroconductive fibers, or the like. Further, as regards the potential regulating member 8, the base portion, thereof to which a voltage is applied and the surface layer thereof brought near to the inner peripheral surface of the intermediary transfer belt 6 may also be formed of other materials.

Further, in this embodiment, similarly as in the embodiment 2, the image forming apparatus 1 includes the distance regulating member 9 for regulating a distance between the potential regulating member 8 and the intermediary transfer belt 6. In this embodiment, the distance regulating member 9 is fixedly provided to the potential regulating member 8. In this embodiment, similarly as in the embodiment 2, the distance regulating member 9 includes an upstream projected portion (projection portion) C projected toward the inner peripheral surface side of the intermediary transfer belt 6 relative to the proximity surface 83 along a direction crossing (in this embodiment, substantially perpendicular to) the proximity surface 83 of the potential regulating member 8 on a side upstream of an upstream end A of the potential regulating member 8. Further, in this embodiment, the distance regulating member 9 includes a downstream projected portion (projection portion) D projected toward the inner peripheral surface side of the intermediary transfer belt 6 relative to the proximity surface 83 along the direction crossing (in this embodiment, substantially perpendicular to) the proximity surface 83 of the potential regulating member 8 on a side downstream of the downstream end B of the potential regulating member 8.

In this embodiment, the distance regulating member 9 is disposed on the side upstream of the upstream end A of the potential regulating member 8 and includes a first distance regulating portion 91 provided with the upstream projected portion C and a supporting portion 92 disposed along a surface of the first portion 81 of the potential regulating member 8 on a side opposite from the proximity surface 83. Further, in this embodiment, the distance regulating member 9 includes a second distance regulating portion 93 disposed on the side downstream of the downstream end B of the potential regulating member 8 and provided with the downstream projected portion D. In this embodiment, constitutions of the first distance regulating portion 91 and the supporting portion 92 of the distance regulating member 9 are the same as the constitutions of the distance regulating portion 91 and the supporting portion 92 of the distance regulating member 9 in the embodiment 2, respectively. In this embodiment, the second distance regulating portion 93 is disposed along the widthwise direction of the intermediary transfer belt 6 and is constituted by a planar member extending in a direction substantially perpendicular to the first portion 81 of the potential regulating member 8. Further, in this embodiment, the distance regulating member 9 is constituted by including the second distance regulating portion 93 separately from the distance regulating portion 91 and the supporting portion 92. In this embodiment, the second distance regulating portion 93 is provided so as to contact a downstream-side end surface of the first portion 81 (and a downstream-side side surface of the second portion 82) of the potential regulating member 8.

Incidentally, the distance regulating member 9 may also function as a supporting member for supporting the potential regulating member 8. Further, the distance regulating member 9 may also be pressed against the inner peripheral surface of the intermediary transfer belt 6 by an urging member (for example, pressing spring constituted by a compression coil spring) as an urging means, for example, in opposite end portions of a longitudinal direction thereof.

The distance regulating member 9 (the first distance regulating portion 91, the supporting portion 92, the second distance regulating portion 93) is constituted by a non-electroconductive material, which is for example, a non-electroconductive resin or the like. In this embodiment, the distance regulating member 9 (the first distance regulating portion 91, the supporting portion 92, the second distance regulating portion 93) is constituted by non-electroconductive POM. Further, in this embodiment, the distance regulating member 9 is constituted so that the first distance regulating portion 91, the supporting portion 92, and the second distance regulating portion 93 extend over a whole region of the first portion 91 (proximity surface 83) of the potential regulating member 8 with respect to the longitudinal direction thereof (the widthwise direction of the intermediary transfer belt 6). That is, in this embodiment, a length of each of the first distance regulating portion 91, the supporting portion 92, and the second distance regulating portion 93 of the distance regulating member 9 in the longitudinal direction is made not less than a length of the first portion 81 (proximity surface 83) of the potential regulating member 8 in the longitudinal direction. That is, in this embodiment, a length range of the potential regulating member 8 in the longitudinal direction is the same as or falls inside a length range of the distance regulating member 9 in the longitudinal direction. Further, in this embodiment, each of the upstream projected portion C and the downstream projected portion D of the distance regulating member 9 is projected toward the inner peripheral surface side of the intermediary transfer belt 6 by 0.5 mm relative to the proximity surface 83 along the direction substantially perpendicular to the proximity surface 83 of the potential regulating member 8.

### 2. Arrangement of Potential Regulating Member and Distance Regulating Member

Next, an arrangement of the potential regulating member 8 and the distance regulating member 9 in this embodiment will be described. Incidentally, in this embodiment, on a side downstream of the primary transfer portions N1, N1m, N1c, and N1k, the potential regulating members 8 (8y, 8m, 8c, 8k) and the distance regulating members 9 (9y, 9m, 9c, 9k) are disposed, respectively. In this embodiment, the constitutions and the arrangements of the potential regulating member 8 and the distance regulating member 9 provided and disposed for each of the primary transfer portions N1y, N1m, N1c, and N1k are substantially the same.

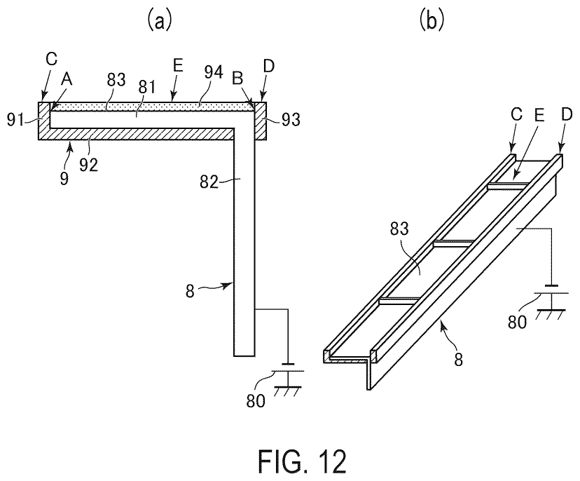

FIG. 11 is a schematic sectional view (cross section substantially perpendicular to the rotational axis direction of the photosensitive drum 11) for illustrating the arrangements of the potential regulating member 8 and the distance regulating member 9 provided between two primary transfer portions N1 adjacent to each other in the feeding direction of the intermediary transfer belt 6. In FIG. 11, as an example, a potential regulating member 8c and the distance regulating member 9c provided between the primary transfer portions N1c for cyan and N1k for black is shown.

In this embodiment, an outer diameter of the photosensitive drum 11, an outer diameter of the primary transfer roller 15, a thickness of the intermediary transfer belt 6, and the offset amount X1 are the same as those in the embodiment 1.

As shown in FIG. 11, the distance regulating member 9 is disposed close to the primary transfer portion N1 on a side downstream of the primary transfer portion N1 so as not to contact the primary transfer roller 15 and so that the upstream projected portion C and the downstream projected portion D contact the inner peripheral surface of the intermediary transfer belt 6. Further, in this embodiment, similarly as in the embodiment 1, the potential regulating member 8 is disposed close to the primary transfer portion N1 on the side downstream of the primary transfer portion N1 so as not to contact the primary transfer roller 15 and the intermediary transfer belt 6. In this embodiment, the potential regulating member 8 is disposed in a position downstream of the primary transfer portion N1 so that a distance X2 from the primary transfer roller 15 to the upstream end A becomes about 10 mm.

As described in the embodiment 1, this distance is not limited thereto, but the above-described distance X2 may preferably be about 1 to 20 mm, typically about 1 to 10 mm.

In this embodiment, similarly as in the embodiment 1, the potential regulating member 8 is disposed so that the proximity surface 83 is substantially parallel to the inner peripheral surface of the intermediary transfer belt 6. the separation distance X3 is regulated by bringing the upstream projected portion C and the downstream projected portion D of the distance regulating member 9 into contact with the inner peripheral surface of the intermediary transfer belt 6, and becomes 0.5 mm. By providing the distance regulating member 9, the separation distance X3 is stabilized. As described in the embodiment 1, the separation distance X3 is not limited thereto, but the separation distance X3 may suitably be about 0.5 to 3.0 mm, typically about 0.5 to 1.5 mm.

Incidentally, the distance regulating member 9 can employ a constitution in which the distance regulating member 9 includes at least one of the upstream projected portion C and the downstream projected portion D.

As described above, according to this embodiment, an effect similar to the effect of the embodiment 1 can be obtained, and in addition, the distance between the intermediary transfer belt 6 and the proximity surface 83 of the potential regulating member 8 can be stabilized.

### Embodiment 4

Next, another embodiment of the present disclosure will be described. The basic structure and operation of an image forming apparatus of this embodiment are the same as those of the image forming apparatuses of the embodiments 1 to 3. Therefore, in the image forming apparatus of this embodiment, elements having the same or corresponding functions or structures as those of the image forming apparatuses of the embodiments 1 to 3 are denoted by the same reference numerals or symbols as those of the embodiments 1 to 3 and detailed description thereof will be omitted.

### 1. Potential Regulating Member and Distance Regulating Member

A constitution of a potential regulating member 8 in this embodiment will be described. Part (a) of FIG. 12 is a schematic sectional view (cross section substantially perpendicular to a rotational axis direction of the photosensitive drum 11) showing the potential regulating member 8 in this embodiment and a distance regulating member 9, described later, in this embodiment, and part (b) of FIG. 12 is a schematic perspective view thereof.

In this embodiment, the constitution of the potential regulating member 8 is the same as the constitution of the potential regulating member 8 shown in FIG. 3, described in the embodiment 1, the potential regulating member 8 shown in FIG. 8 described in the embodiment 2, and the potential regulating member 8 shown in FIG. 10 described in the embodiment 3.

Further, in this embodiment, similarly as in the embodiments 2 and 3, the image forming apparatus 1 includes the distance regulating member 9 for regulating a distance between the potential regulating member 8 and the intermediary transfer belt 6. In this embodiment, the distance regulating member 9 is fixedly provided to the potential regulating member 8. In this embodiment, the distance regulating member 9 includes the upstream projected portion C and the downstream projected portion D similar to those in the embodiment 3. Further, in this embodiment, the distance regulating member 9 includes a central projected portion (projection portion) E provided between the proximity surface 83 and the inner peripheral surface of the intermediary transfer belt 6 so as to partially cover the proximity surface 83 of the potential regulating member 8.

In this embodiment, the distance regulating member 9 includes the first distance regulating portion 91, the supporting portion 92, and the second distance regulating portion 93 similar to those in the embodiment 3. Further, in this embodiment, the distance regulating member 9 includes a plurality of (in this embodiment, three) ribs 94 each extending along the feeding direction of the intermediary transfer belt 6 so as to connect the first distance regulating portion 91 and the second distance regulating portion 93 in a plurality of positions with respect to the widthwise direction of the intermediary transfer belt 6 and each constituting the central projected portion E. Further, in this embodiment, the distance regulating member 9 is prepared by integrally connecting the first distance regulating portion 91 and the second distance regulating portion 93 with the rib 94. In this embodiment, the rib 94 is provided so as to contact the proximity surface 83 of the potential regulating member 8. Incidentally, widths and the number of the ribs 94 with respect to the widthwise direction of the intermediary transfer belt 6 can be appropriately set on the basis of a viewpoint of stabilizing the separation distance X3, or the like. The ribs 94 may also be a single rib, but are typically provided in plurality (for example, two to ten ribs). Further, an interval between adjacent ribs 94 (or a distance between the rib 94 and an end portion of the potential regulating member 8) with respect to the widthwise direction of the intermediary transfer belt 6 is typically made substantially the same interval (substantially the same distance).

Incidentally, the distance regulating member 9 may also function as a supporting member for supporting the potential regulating member 8. Further, the distance regulating member 9 may also be pressed against the inner peripheral surface of the intermediary transfer belt 6 by an urging member (for example, pressing spring constituted by a compression coil spring) as an urging means, for example, in opposite end portions of a longitudinal direction thereof.

The distance regulating member 9 (the first distance regulating portion 91, the supporting portion 92, the second distance regulating portion 93, the rib 94) is constituted by a non-electroconductive material, which is for example, a non-electroconductive resin or the like. In this embodiment, the distance regulating member 9 (the first distance regulating portion 91, the supporting portion 92, the second distance regulating portion 93, the rib 94) is constituted by non-electroconductive POM. Further, in this embodiment, each of the upstream projected portion C, the downstream projected portion D and the central projected portion E (rib 94) of the distance regulating member 9 is projected toward the inner peripheral surface side of the intermediary transfer belt 6 by 0.5 mm relative to the proximity surface 83 along the direction substantially perpendicular to the proximity surface 83 of the potential regulating member 8.

### 2. Arrangement of Potential Regulating Member and Distance Regulating Member

Next, an arrangement of the potential regulating member 8 and the distance regulating member 9 in this embodiment will be described. Incidentally, in this embodiment, on a side downstream of the primary transfer portions N1, N1m, N1c, and N1k, the potential regulating members 8 (8y, 8m, 8c, 8k) and the distance regulating members 9 (9y, 9m, 9c, 9k) are disposed, respectively. In this embodiment, the constitutions and the arrangements of the potential regulating member 8 and the distance regulating member 9 provided and disposed for each of the primary transfer portions N1y, N1m, N1c, and N1k are substantially the same.

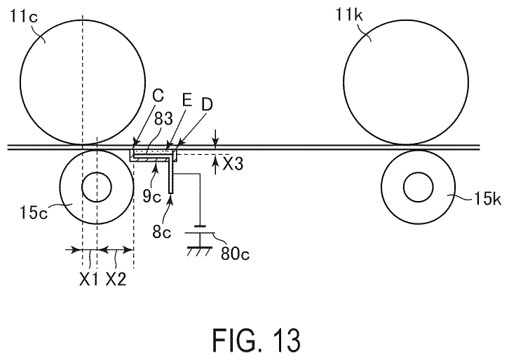

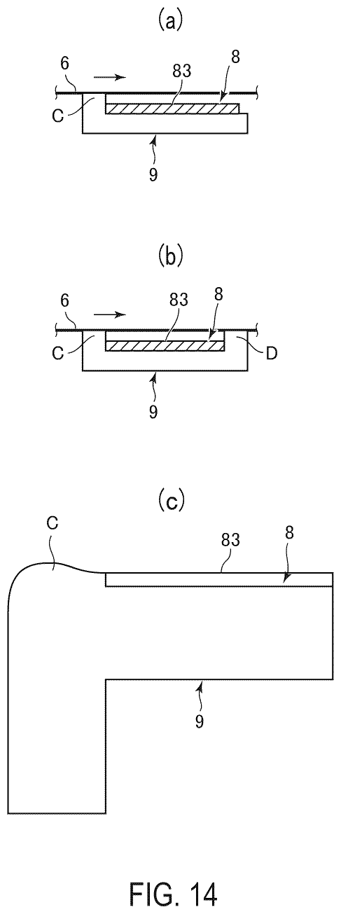

FIG. 13 is a schematic sectional view (cross section substantially perpendicular to the rotational axis direction of the photosensitive drum 11) for illustrating the arrangements of the potential regulating member 8 and the distance regulating member 9 provided between two primary transfer portions N1 adjacent to each other in the feeding direction of the intermediary transfer belt 6. In FIG. 13, as an example, a potential regulating member 8c and the distance regulating member 9c provided between the primary transfer portions N1c for cyan and N1k for black is shown.

In this embodiment, an outer diameter of the photosensitive drum 11, an outer diameter of the primary transfer roller 15, a thickness of the intermediary transfer belt 6, and the offset amount X1 are the same as those in the embodiment 1.

As shown in FIG. 13, the distance regulating member 9 is disposed close to the primary transfer portion N1 on a side downstream of the primary transfer portion N1 so as not to contact the primary transfer roller 15 and so that the upstream projected portion C, the downstream projected portion D, and the central projected portion E contact the inner peripheral surface of the intermediary transfer belt 6. Further, in this embodiment, similarly as in the embodiment 1, the potential regulating member 8 is disposed close to the primary transfer portion N1 on the side downstream of the primary transfer portion N1 so as not to contact the primary transfer roller 15 and the intermediary transfer belt 6. In this embodiment, the potential regulating member 8 is disposed in a position downstream of the primary transfer portion N1 so that a distance X2 from the primary transfer roller 15 to the upstream end A becomes about 10 mm. As described in the embodiment 1, this distance is not limited thereto, but the above-described distance X2 may preferably be about 1 to 20 mm, typically about 1 to 10 mm.

In this embodiment, similarly as in the embodiment 1, the potential regulating member 8 is disposed so that the proximity surface 83 is substantially parallel to the inner peripheral surface of the intermediary transfer belt 6. the separation distance X3 is regulated by bringing the upstream projected portion C, the downstream projected portion D, and the central projected portion E of the distance regulating member 9 into contact with the inner peripheral surface of the intermediary transfer belt 6, and becomes 0.5 mm. By providing the distance regulating member 9, the separation distance X3 is stabilized. As described in the embodiment 1, the separation distance X3 is not limited thereto, but the separation distance X3 may suitably be about 0.5 to 3.0 mm, typically about 0.5 to 1.5 mm.

Incidentally, the distance regulating member 9 can employ a constitution in which the distance regulating member 9 includes at least one of the upstream projected portion C and the downstream projected portion D, and the central projected portion E (rib 94). Further, the distance regulating member 9 may also have a constitution in which the distance regulating member 9 does not include the upstream projected portion C and the downstream projected portion D, but includes the central projected portion E (rib 94).

As described above, according to this embodiment, an effect similar to the effect of the embodiment 1 can be obtained, and in addition, the distance between the intermediary transfer belt 6 and the proximity surface 83 of the potential regulating member 8 can be stabilized.

### Embodiment 5

Next, another embodiment of the present disclosure will be described. The basic structure and operation of an image forming apparatus of this embodiment are the same as those of the image forming apparatuses of the embodiments 1 to 4. Therefore, in the image forming apparatus of this embodiment, elements having the same or corresponding functions or structures as those of the image forming apparatuses of the embodiments 1 to 4 are denoted by the same reference numerals or symbols as those of the embodiments 1 to 4 and detailed description thereof will be omitted.

In this embodiment, some modified embodiments of the potential regulating member 8 and the distance regulating member 9 will be described. Parts (a) to (c) of FIG. 14 are schematic sectional views (cross sections substantially perpendicular to the rotational axis direction of the photosensitive drum 11) for illustrating the modified embodiments of the potential regulating member 8 and the distance regulating member 9.

In the above-described embodiments, the potential regulating member 8 had the constitution including the first portion 81 and the second portion 82, but the potential regulating member 8 may also be constituted by a flat plate corresponding to the first portion 81 in the above-described embodiments. Further, as shown in parts (a) and (b) of FIG. 14, to the potential regulating member 8 constituted by the flat plate, the distance regulating member 9 provided with the upstream projected portion C, or the upstream projected portion C and the downstream projected portion D described in the embodiments 2 and 3 can be provided. For example, in a constitution in which the distance regulating member 9 includes the upstream projected portion C and the downstream projected portion D as shown in part (b) of FIG. 14, the distance regulating member 9 may further include the central projected portion E described in the embodiment 4. The distance regulating member 9 may also function as the supporting member for the potential regulating member 8.

Further, the upstream projected portion C of the distance regulating member 9 described in the embodiments 2 and 3 has a substantially rectangular shape in cross section, but as shown in part (c) of FIG. 14, in the cross section, a surface of the upstream projected portion C opposing the inner peripheral surface of the intermediary transfer belt 6 may also be formed in a curved surface shape. By this, it is possible to reduce a possibility that scars are generated on the inner peripheral surface of the intermediary transfer belt 6 by friction between the inner peripheral surface of the intermediary transfer belt 6 and the distance regulating member 9. The same applies to the downstream projected portion D.

Further, in portions where the upstream projected portion C, the downstream projected portion D, or the central projected portion E of the distance regulating member 9 described in the embodiments 2 to 4 contacts the intermediary transfer belt 6, a contact portion constituted by a flexible elastic material (non-electroconductive material) may also be provided. As such a material, it is possible to use a nonwoven fabric, a felt, or a pile fabric which are constituted by using non-electroconductive fibers, or a sponge (foamed elastic material) constituted by using a non-electroconductive rubber material, or the like. The contact portion formed with such materials can be provided by being fixed, with an arbitrary fixing means such as an adhesive, to for example, the upstream projected portion C, the downstream projected portion D, or the central projected portion E in the embodiments 2 to 4. By this, it is possible to reduce the possibility that the scars are generated on the inner peripheral surface of the intermediary transfer belt 6 by the friction between the inner peripheral surface of the intermediary transfer belt 6 and the potential regulating member 8.

### Other Embodiments

In the above, the present disclosure was described based on specific embodiments, but the present disclosure is not limited to the above-described embodiments.

In the above-described embodiments, the potential regulating power source was provided independently for each of the image forming units, but may also be made common to the plurality (or all) of image forming units. The same applies to the charging power source, the developing power source, and the primary transfer power source.

Further, in the above-described embodiments, the potential regulating member 8 was disposed so that in the cross section substantially perpendicular to the rotational axis direction of the photosensitive drum 11, a rectilinear line passing through the upstream end A and the downstream end B of the proximity surface 83 and the rectilinear line L are substantially parallel to each other, but is not limited thereto. The potential regulating member 8 may also be disposed with an angle (for example, 30 degrees or less, preferably 15 degrees or less) of the rectilinear line passing through the upstream end A and the downstream end B of the proximity surface 83 with respect to the rectilinear line L.

Further, the surface of the potential regulating member 8 opposing the inner peripheral surface of the intermediary transfer belt 6 is not limited to the flat surface. For example, the potential regulating member 8 may be constituted by a curved plate bent in a curved shape which projects toward the photosensitive drum 11 side in a cross section substantially perpendicular to the rotational axis direction of the photosensitive drum 11, and the surface of the potential regulating member 8 opposing the inner peripheral surface of the intermediary transfer belt 6 may also be a curved surface projecting toward the photosensitive drum 11 side.

Further, in the above-described embodiments, the potential regulating member (electrode member) of which proximity surface close to the intermediary transfer belt is the flat surface was the plate-like member formed with the metal plate, but when a similar proximity surface can be formed, for example, another form such as a black-like member rectangular in cross section may also be used. The same applies to the potential regulating member (electrode member) of which proximity surface opposing the inner peripheral surface of the intermediary transfer belt is a curved surface.

Further, in the above-described embodiments, the primary transfer member was the roller-shaped member, but may also be a brush-like member, a sheet-like member, a pad-like member, and the like.

Further, in the above-described embodiments, the predetermined charge polarity of the photosensitive member was the negative polarity, but is not limited thereto. The predetermined charge polarity of the photosensitive member may also be the positive polarity. Similarly, in the above-described embodiments, the normal charge polarity of the toner was the negative polarity, but may also be the positive polarity. Various applied voltages in the case where the predetermined charge polarity of the photosensitive member and the normal charge polarity of the toner are the positive polarity may only be required to be appropriately changed such that these polarities are changed to the polarity opposite to the polarity in the above-described embodiments in accordance with the above-described embodiments.

Further, the image forming apparatus can have a constitution including the potential regulating member (and further the distance regulating member) for at least one of the plurality of image forming units. That is, the image forming apparatus can have a constitution in which the potential regulating member (and further the distance regulating member) are provided on the inner peripheral surface side of the intermediary transfer belt in a position immediately close to at least one of the plurality of primary transfer portions on a side downstream of the associated primary transfer portion.

Further, the image forming apparatus is not limited to the image forming apparatus capable of forming a full-color image, but may also be an image forming apparatus capable of forming only a monochromatic (white/black or monocolor) image.

According to the present disclosure, in the image forming apparatus of the intermediary transfer type, it is possible to improve a transfer property of the toner image onto the recording material, relatively difficult in transfer of the toner image, such as the embossed paper while alleviating the toner scattering.

While the present disclose has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-188681 filed on Oct. 25, 2024, which is hereby incorporated by reference herein in its entirety.

What is claimed is:

1. An image forming apparatus comprising:
a photosensitive member capable of being electrically charged to a predetermined polarity and configured to bear a toner image;
an intermediary transfer belt configured to convey the toner image transferred from the photosensitive member and capable of being circulated and moved;
a transfer member configured to transfer the toner image from the photosensitive member onto the intermediary transfer belt;
an electrode member provided on a side downstream of the transfer member with respect to a movement direction of the intermediary transfer belt and on an inner peripheral surface side of the intermediary transfer belt;
a power source configured to apply a voltage of the same polarity as the predetermined polarity to the electrode member; and
a supporting member configured to support the electrode member,
wherein the electrode member is supported in non-contact with the intermediary transfer belt when the electrode member is positioned in an operating position, and a separation amount between the electrode member and the intermediary transfer belt when the electrode member is positioned in the operating position is 1.5 mm or less.

2. The image forming apparatus according to claim 1, wherein the separation amount between the electrode member and the intermediary transfer belt when the electrode member is positioned in the operating position is 0.5 mm or more.

3. The image forming apparatus according to claim 1, the electrode member includes a proximity surface which is a surface opposing the inner peripheral surface of the intermediary transfer belt, and the proximity surface is a flat surface.

4. The image forming apparatus according to claim 1, wherein the supporting portion includes a projected portion projecting toward the inner peripheral surface side of the intermediary transfer belt relative to the electrode member, and the projected portion is formed of a non-electroconductive material for regulating a separation distance of the electrode member from the intermediary transfer belt in contact with the inner peripheral surface of the intermediary transfer belt.

5. The image forming apparatus according to claim 4, wherein the projected portion is provided on a side downstream of the transfer member and upstream of the electrode member with respect to the movement direction.

6. The image forming apparatus according to claim 4, wherein the projected portion is provided on a side downstream of the electrode member with respect to the movement direction.

7. The image forming apparatus according to claim 4, wherein the projected portion is provided between the electrode member and the inner peripheral surface of the intermediary transfer belt.

8. An image forming apparatus comprising:
a photosensitive member capable of being electrically charged to a predetermined polarity and configured to bear a toner image;
an intermediary transfer belt configured to convey the toner image transferred from the photosensitive member and capable of being circulated and moved;
a transfer member configured to transfer the toner image from the photosensitive member onto the intermediary transfer belt;
an electrode member provided on a side downstream of the transfer member with respect to a movement direction of the intermediary transfer belt and on an inner peripheral surface side of the intermediary transfer belt;
a power source configured to apply a voltage of the same polarity as the predetermined polarity to the electrode member; and
a supporting member configured to support the electrode member,
wherein the electrode member is supported in non-contact with the intermediary transfer belt when the electrode member is positioned in an operating position, and
wherein the supporting portion includes a projected portion projecting toward the inner peripheral surface side of the intermediary transfer belt relative to the electrode member, and the projected portion is formed of a non-electroconductive material for regulating a separation distance of the electrode member from the intermediary transfer belt in contact with the inner peripheral surface of the intermediary transfer belt.
